(19) United States
(12) Patent Application Publication
(10) Pub. No.: US 2013/0177083 A1
(43) Pub. Date: Jul. 11, 2013

(54) MOTION VECTOR CANDIDATE INDEX SIGNALING IN VIDEO CODING

(71) Applicant: Qualcomm Incorporated, San Diego, CA (US)

(72) Inventors: Jianle Chen, San Diego, CA (US); Xianglin Wang, San Diego, CA (US); Vadim Seregin, San Diego, CA (US); Marta Karczewicz, San Diego, CA (US)

(73) Assignee: QUALCOMM INCORPORATED, San Diego, CA (US)

(21) Appl. No.: 13/733,736

(22) Filed: Jan. 3, 2013

Related U.S. Application Data
(60) Provisional application No. 61/583,572, filed on Jan. 5, 2012.
(60) Provisional application No. 61/587,052, filed on Jan. 16, 2012.

(51) Int. Cl. H04N 7/26

(52) U.S. Cl. CPC H04N 19/00696
USPC 375/240.16

(57) ABSTRACT

A video encoder generates a first and a second candidate list. The first candidate list includes a plurality of motion vector (MV) candidates. The video encoder selects, from the first candidate list, a MV candidate for a first prediction unit (PU) of a coding unit (CU). The second MV candidate list includes each of the MV candidates of the first MV candidate list except the MV candidate selected for the first PU. The video encoder selects, from the second MV candidate list, a MV candidate for a second PU of the CU. A video decoder generates the first and second MV candidate lists in a similar way and generates predictive sample blocks for the first and second PUs based on motion information of the selected MV candidates.

This application claims the benefit of U.S. Provisional Patent Application No. 61/583,572, filed Jan. 5, 2012, and U.S. Provisional Patent Application No. 61/587,052, filed Jan. 16, 2012, the entire content of both of which are incorporated herein by reference.

### TECHNICAL FIELD

This disclosure relates to video coding and compression and, in particular, to signaling of motion information.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards, to transmit, receive and store digital video information more efficiently.

Video compression techniques perform spatial (intra-picture) prediction and/or temporal (inter-picture) prediction to reduce or remove redundancy inherent in video sequences. For block-based video coding, a video slice may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

### SUMMARY

In general, this disclosure describes techniques for signaling motion information in video coding when a motion prediction mode is used. A video encoder generates a first motion vector (MV) candidate list. The first MV candidate list includes a plurality of MV candidates for use in a motion prediction mode. In addition, the video encoder selects, from the first MV candidate list, a MV candidate for a first prediction unit (PU) of a coding unit (CU). The video encoder also generates a second MV candidate list. The second MV candidate list includes each of the MV candidates of the first MV candidate list except the MV candidate selected for the first PU. Thus, the second MV candidate list may include one fewer MV candidates than the first MV candidate list. The video encoder selects, from the second MV candidate list, a MV candidate for a second PU of the CU. A video decoder generates the first and second MV candidate lists and generates predictive sample blocks for the first and second PUs based in part on motion information of the selected MV candidates.

In one aspect, this disclosure describes a method for encoding video data. The method comprises encoding a CU of the video data. The CU has at least a first PU and a second PU. Encoding the CU comprises generating a first MV candidate list, the first MV candidate list including a plurality of MV candidates. Encoding the CU also comprises selecting, from the first MV candidate list, a MV candidate for the first PU. In addition, encoding the CU comprises generating a second MV candidate list, the second MV candidate list including each of the MV candidates in the first MV candidate list except the MV candidate selected for the first PU. Encoding the CU also comprises selecting, from the second MV candidate list, a MV candidate for the second PU.

In another aspect, this disclosure describes a method for decoding video data. The method comprises generating a first MV candidate list, the first MV candidate list including a plurality of MV candidates. The method also comprises generating, based in part on motion information of a selected MV candidate in the first MV candidate list, a predictive sample block for a first PU of a CU. In addition, the method comprises generating a second MV candidate list. The second MV candidate list includes each MV candidate in the first MV candidate list except the selected MV candidate in the first MV candidate list. Furthermore, the method comprises generating, based in part on motion information of a MV candidate in the second MV candidate list, a predictive sample block for a second PU of the CU. The method also comprises generating, based in part on the predictive sample blocks of the first and second PUs, a sample block of the CU.

In another aspect, this disclosure describes a video encoding device comprising one or more processors configured to generate a first MV candidate list, the first MV candidate list including a plurality of MV candidates. The one or more processors are also configured to select, from the first MV candidate list, a MV candidate for a first PU of a CU. In addition, the one or more processors are configured to generate a second MV candidate list. The second MV candidate list includes each of the MV candidates in the first MV candidate list except the MV candidate selected for the first PU. The one or more processors are also configured to select, from the second MV candidate list, a MV candidate for a second PU of the CU.

In another aspect, this disclosure describes a video decoding device comprising one or more processors configured to generate a first MV candidate list, the first MV candidate list including a plurality of MV candidates. The one or more processors are configured to generate, based in part on motion information of a selected MV candidate in the first MV candidate list, a predictive sample block for a first PU of a CU. In addition, the one or more processors are configured to generate a second MV candidate list. The second MV candidate list includes each MV candidate in the first MV candidate list except the selected MV candidate in the first MV candidate list. Furthermore, the one or more processors are configured to generate, based in part on motion information of a MV candidate in the second MV candidate list, a predictive sample block for a second PU of the CU. In addition, the one or more processors are configured to generate, based in part on the predictive sample blocks of the first and second PUs, a sample block of the CU.

In another aspect, this disclosure describe a video encoding device that comprises means for generating a first MV candidate list, the first MV candidate list including a plurality of MV candidates. The video encoding device also comprises means for selecting, from the first MV candidate list, a MV candidate for a first PU of a CU. In addition, the video encoding device comprises means for generating a second MV candidate list. The second MV candidate list includes each of the MV candidates in the first MV candidate list except the MV candidate selected for the first PU. Furthermore, the video encoding device comprises means for selecting, from the second MV candidate list, a MV candidate for the second PU.

In another aspect, this disclosure describes a video decoding device comprising means for generating a first MV candidate list, the first MV candidate list including a plurality of MV candidates. The video decoding device also comprises means for generating, based in part on motion information of a selected MV candidate in the first MV candidate list, a predictive sample block for a first PU of a CU. The video decoding device also comprises means for generating a second MV candidate list. The second MV candidate list includes each MV candidate in the first MV candidate list except the selected MV candidate in the first MV candidate list. Furthermore, the video decoding device comprises means for generating, based in part on motion information of a MV candidate in the second MV candidate list, a predictive sample block for a second PU of the CU. In addition, the video decoding device comprises means for generating, based in part on the predictive sample blocks of the first and second PUs, a sample block of the CU.

In another aspect, this disclosure describes a computer-readable storage medium storing instructions that, when executed by one or more processors of a video encoding device, configure the video encoding device to generate a first MV candidate list, the first MV candidate list including a plurality of MV candidates. The instructions also configure the video encoding device to select, from the first MV candidate list, a MV candidate for a first PU of a CU. Furthermore, the instructions configure the video encoding device to generate a second MV candidate list. The second MV candidate list includes each of the MV candidates in the first MV candidate list except the MV candidate selected for the first PU. The instructions also configure the video encoding device to select, from the second MV candidate list, a MV candidate for a second PU of the CU.

In another aspect, this disclosure describes a computer-readable storage medium storing instructions that, when executed by one or more processors of a video decoding device, configure the video decoding device to generate a first MV candidate list, the first MV candidate list including a plurality of MV candidates. The instructions also cause the video decoding device to generate, based in part on motion information of a selected MV candidate in the first MV candidate list, a predictive sample block for a first PU of a CU. In addition, the instructions cause the video decoding device to generate a second MV candidate list. The second MV candidate list includes each MV candidate in the first MV candidate list except the selected MV candidate in the first MV candidate list. Furthermore, the instructions cause the video decoding device to generate, based in part on motion information of a MV candidate in the second MV candidate list, a predictive sample block for a second PU of the CU. In addition, the instructions cause the video decoding device to generate, based in part on the predictive sample blocks of the first and second PUs, a sample block of the CU.

The details of one or more examples of the disclosure are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video coding system that may utilize the techniques of this disclosure.

FIGS. 2A and 2B are conceptual diagrams illustrating example locations covered by motion vector (MV) candidates in MV candidate lists of prediction units (PUs) of a coding unit (CU).

FIG. 3 is a conceptual diagram illustrating example locations covered by MV candidates in a single MV candidate list for a CU.

FIG. 4 is a block diagram illustrating an example video encoder that may implement the techniques of this disclosure.

FIG. 5 is a block diagram illustrating an example video decoder that may implement the techniques of this disclosure.

FIG. 6 is a flowchart illustrating an example operation of a video encoder, in accordance with one or more techniques of this disclosure.

FIG. 7 is a flowchart illustrating an example operation of a video decoder, in accordance with one or more techniques of this disclosure.

FIGS. 8A, 8B, and 8C are conceptual diagrams illustrating example locations covered by MV candidates.

FIGS. 9A-9C are conceptual diagrams illustrating example locations of MV candidates where the locations of the MV candidates are dependent on a partitioning mode of a CU.

FIG. 10 is a conceptual diagram illustrating a group of CUs and a set of spatial and temporal MV candidate locations.

### DETAILED DESCRIPTION

A coding unit (CU) includes one or more prediction units (PUs). A video encoder may signal motion information of a PU using motion prediction modes, such as merge/skip mode or advanced motion vector prediction (AMVP) mode. The motion information of the PU may include one or more motion vectors, one or more reference picture indexes, and a prediction direction indicator. When the video encoder signals the motion information of a PU using merge/skip mode or AMVP mode, the video encoder may signal, in a bitstream, a motion vector (MV) index for the PU. The MV index identifies a MV candidate, within an MV candidate list, to be used to provide motion information for the PU.

A video decoder may parse the MV index from the bitstream. In addition, the video decoder may generate the MV candidate list for the PU. The MV candidate list may include a plurality of MV candidates. The MV candidate list may include different numbers of MV candidates depending on whether the motion information of the PU is signaled using merge/skip mode or AMVP mode. The MV candidates may include spatial MV candidates and a temporal MV candidate. The spatial MV candidates may be PUs that cover locations that are within the same picture as the PU and that are spatially adjacent to the PU or the CU associated with the PU. The temporal MV candidate may be a PU of a picture other than the picture associated with the PU that the video decoder is currently decoding, and may be associated with a co-located PU in the other picture.

If the motion information of the PU is signaled in merge/skip mode, the video decoder may determine that the motion information of the PU is the same as the motion information of a MV candidate at a position in the MV candidate list indicated by the MV index. In this case, the PU is coded to use the motion vector, reference picture index and prediction direction associated with the MV candidate. If the motion information of the PU is signaled in AMVP mode, the video decoder may parse, from the bitstream, a motion vector difference (MVD). In AMVP mode, the video decoder may then determine a motion vector of the PU by adding the MVD to a motion vector of a MV candidate at a position in the MV candidate list indicated by the MV index. However, in contrast to merge/skip mode, the PU coded in AMVP mode may have a reference picture index and prediction direction that are the same as, or different than, the reference picture index and prediction direction of the selected MV candidate. The video decoder may use the motion information of the PU to generate predictive sample block for the PU. The video decoder uses the predictive sample blocks for the PU to reconstruct sample blocks for a CU associated with the PU.

In one approach, the video decoder generates different MV candidate lists for different PUs of a CU. Different locations are covered by MV candidates in different MV candidate lists. Generating different MV candidate lists for different PUs of a CU may increase the complexity of the video encoder and the video decoder. In another approach, the video decoder generates a single common MV candidate list for all PUs of a CU. Generating a single MV candidate list for all PUs of a CU may decrease coding efficiency as compared to generating different MV candidate lists for different PUs of a CU. The techniques of this disclosure attempt to balance the benefits of these proposals.

In accordance with the techniques of this disclosure, the video decoder may generate a first MV candidate list for a first (in coding order) PU of a CU. Each MV candidate in the first MV candidate list may cover a different location adjacent to the sample blocks of the CU. In addition, the video decoder may generate subsequent MV candidate lists for subsequent (in coding order) PUs of the CU. Each subsequent MV candidate list includes each MV candidate of a MV candidate list for an immediately-previous (in coding order) PU of the CU, except for an MV candidate indicated by a MV index for the immediately-previous PU. Thus, each subsequent MV candidate list includes one fewer MV candidate than the MV candidate list for the immediately-previous PU of the CU. Because the subsequent MV candidate lists include fewer MV candidates, fewer bits may be needed to signal the MV indexes for the subsequent PUs. This may improve coding efficiency. At the same time, generating the MV candidate lists in accordance with the techniques of this disclosure may be less complex than generating MV candidate lists that include MV candidates that cover different locations, as previously proposed.

The attached drawings illustrate examples. Elements indicated by reference numbers in the attached drawings correspond to elements indicated by like reference numbers in the following description. In this disclosure, elements having names that start with ordinal words (e.g., “first,” “second,” “third,” and so on) do not necessarily imply that the elements have a particular order. Rather, such ordinal words may merely be used to refer to different elements of a same or similar type.

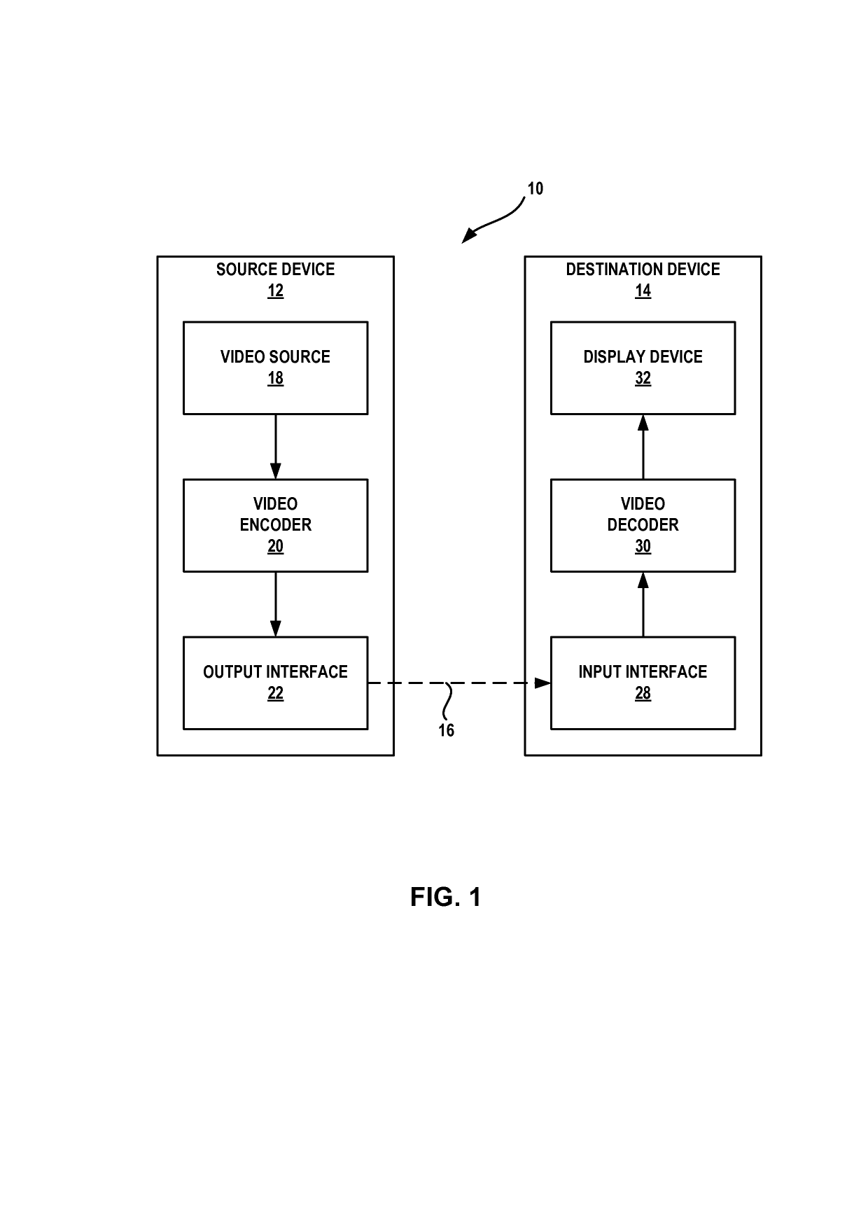

FIG. 1 is a block diagram illustrating an example video coding system 10 that may utilize the techniques of this disclosure. As described herein, the term “video coder” refers generically to both video encoders and video decoders. In this disclosure, the terms “video coding” or “coding” may refer generically to video encoding or video decoding.

As shown in FIG. 1, video coding system 10 includes a source device 12 and a destination device 14. Source device 12 generates encoded video data. Accordingly, source device 12 may be referred to as a video encoding device or a video encoding apparatus. Destination device 14 may decode the encoded video data generated by source device 12. Accordingly, destination device 14 may be referred to as a video decoding device or a video decoding apparatus. Source device 12 and destination device 14 may be examples of video coding devices or video coding apparatuses.

Source device 12 and destination device 14 may comprise a wide range of devices, including desktop computers, mobile computing devices, notebook (e.g., laptop) computers, tablet computers, set-top boxes, telephone handsets such as so-called “smart” phones, televisions, cameras, display devices, digital media players, video gaming consoles, in-car computers, or the like.

Destination device 14 may receive encoded video data from source device 12 via a channel 16. Channel 16 may comprise one or more media or devices capable of moving the encoded video data from source device 12 to destination device 14. In one example, channel 16 may comprise one or more communication media that enable source device 12 to transmit encoded video data directly to destination device 14 in real-time. In this example, source device 12 may modulate the encoded video data according to a communication standard, such as a wireless communication protocol, and may transmit the modulated video data to destination device 14. The one or more communication media may include wireless and/or wired communication media, such as a radio frequency (RF) spectrum or one or more physical transmission lines. The one or more communication media may form part of a packet-based network, such as a local area network, a wide-area network, or a global network (e.g., the Internet). Channel 16 may include various types of devices, such as routers, switches, base stations, or other equipment that facilitate communication from source device 12 to destination device 14.

In another example, channel 16 may include to a storage medium that stores encoded video data generated by source device 12. In this example, destination device 14 may access the storage medium via disk access or card access. The storage medium may include a variety of locally-accessed data storage media such as Blu-ray discs, DVDs, CD-ROMs, flash memory, or other suitable digital storage media for storing encoded video data.

In a further example, channel 16 may include a file server or another intermediate storage device that stores encoded video data generated by source device 12. In this example, destination device 14 may access encoded video data stored at the file server or other intermediate storage device via streaming or download. The file server may be a type of server capable of storing encoded video data and transmitting the encoded video data to destination device 14. Example file servers include web servers (e.g., for a website), file transfer protocol (FTP) servers, network attached storage (NAS) devices, and local disk drives.

Destination device 14 may access the encoded video data through a standard data connection, such as an Internet connection. Example types of data connections may include wireless channels (e.g., Wi-Fi connections), wired connections (e.g., DSL, cable modem, etc.), or combinations of both that are suitable for accessing encoded video data stored on a file server. The transmission of encoded video data from the file server may be a streaming transmission, a download transmission, or a combination of both.

The techniques of this disclosure are not limited to wireless applications or settings. The techniques may be applied to video coding in support of a variety of multimedia applications, such as over-the-air television broadcasts, cable television transmissions, satellite television transmissions, streaming video transmissions, e.g., via the Internet, encoding of video data for storage on a data storage medium, decoding of video data stored on a data storage medium, or other applications. In some examples, video coding system 10 may be configured to support one-way or two-way video transmission to support applications such as video streaming, video playback, video broadcasting, and/or video telephony.

In the example of FIG. 1, source device 12 includes a video source 18, a video encoder 20, and an output interface 22. In some examples, output interface 22 may include a modulator/demodulator (modem) and/or a transmitter. Video source 18 may include a video capture device, e.g., a video camera, a video archive containing previously-captured video data, a video feed interface to receive video data from a video content provider, and/or a computer graphics system for generating video data, or a combination of such sources of video data.

Video encoder 20 may encode video data from video source 18. In some examples, source device 12 directly transmits the encoded video data to destination device 14 via output interface 22. In other examples, the encoded video data may also be stored onto a storage medium or a file server for later access by destination device 14 for decoding and/or playback.

In the example of FIG. 1, destination device 14 includes an input interface 28, a video decoder 30, and a display device 32. In some examples, input interface 28 includes a receiver and/or a modem. Input interface 28 may receive encoded video data over channel 16. Display device 32 may be integrated with or may be external to destination device 14. In general, display device 32 displays decoded video data. Display device 32 may comprise a variety of display devices, such as a liquid crystal display (LCD), a plasma display, an organic light emitting diode (OLED) display, or another type of display device.

In some examples, video encoder 20 and video decoder 30 operate according to a video compression standard, such as ISO/IEC MPEG-4 Visual and ITU-T H.264 (also known as ISO/IEC MPEG-4 AVC), including its Scalable Video Coding (SVC) and Multiview Video Coding (MVC) extensions. In other examples, video encoder 20 and video decoder 30 may operate according to other video compression standards, including the High Efficiency Video Coding (HEVC) standard presently under development. A draft of the upcoming HEVC standard, referred to as “HEVC Working Draft 6,” is described in Bross et al., “High Efficiency Video Coding (HEVC) text specification draft 6,” Joint Collaborative Team on Video Coding (JCT-VC) of ITU-T SG16 WP3 and ISO/IEC JTC1/SC29/WG11, 7th Meeting: Geneva, Switzerland, November, 2011, which, as of Dec. 18, 2012, is downloadable from http://phenix.it-sudparis.eu/jct/doc_end_user/documents/7_Geneva/wg11/JCTVC-G1103-v3.zip, the entire content of which is incorporated herein by reference. Another draft of the upcoming HEVC standard, referred to as “HEVC Working Draft 9,” is described in Bross et al., “High Efficiency Video Coding (HEVC) text specification draft 9,” Joint Collaborative Team on Video Coding (JCT-VC) of ITU-T SG16 WP3 and ISO/IEC JTC1/SC29/WG11, 11th Meeting: Shanghai, China, October, 2012, which, as of Dec. 18, 2012, is downloadable from http://phenix.int-evry.fr/jct/doc_end_user/documents/11_Shanghai/wg11/JCTVC-K1003-v8.zip, the entire content of which is incorporated herein by reference. The techniques of this disclosure, however, are not limited to any particular coding standard or technique.

FIG. 1 is merely an example and the techniques of this disclosure may apply to video coding settings (e.g., video encoding or video decoding) that do not necessarily include any data communication between the video encoding and video decoding devices. In other examples, data is retrieved from a local memory, streamed over a network, or the like. A video encoding device may encode and store data to memory, and/or a video decoding device may retrieve and decode data from memory. In many examples, the video encoding and decoding is performed by devices that do not communicate with one another, but simply encode data to memory and/or retrieve and decode data from memory.

Video encoder 20 and video decoder 30 each may be implemented as any of a variety of suitable circuitry, such as one or more microprocessors, digital signal processors (DSPs), application-specific integrated circuits (ASICs), field-programmable gate arrays (FPGAs), discrete logic, hardware, or any combinations thereof. If the techniques are implemented partially in software, a device may store instructions for the software in a suitable, non-transitory computer-readable storage medium and may execute the instructions in hardware using one or more processors to perform the techniques of this disclosure. Any of the foregoing (including hardware, software, a combination of hardware and software, etc.) may be considered to be one or more processors. Each of video encoder 20 and video decoder 30 may be included in one or more encoders or decoders, either of which may be integrated as part of a combined encoder/decoder (CODEC) in a respective device.

This disclosure may generally refer to video encoder 20 “signaling” certain information. The term “signaling” may generally refer to the communication of syntax elements and/or other data used to decode the compressed video data. Such communication may occur in real- or near-real-time. Alternately, such communication may occur over a span of time, such as might occur when storing syntax elements to a computer-readable storage medium in an encoded bitstream at the time of encoding, which a video decoding device may then retrieve at any time after being stored to this medium.

As mentioned briefly above, video encoder 20 encodes video data. The video data may comprise one or more pictures. Each of the pictures is a still image forming part of a video. When video encoder 20 encodes the video data, video encoder 20 may generate a bitstream. The bitstream may include a sequence of bits that form a coded representation of the video data. The bitstream may include coded pictures and associated data. A coded picture is a coded representation of a picture. The associated data may include sequence parameter sets (SPSs), picture parameter sets (PPSs), and other syntax structures. A SPS may contain parameters applicable to zero or more sequences of pictures. A PPS may contain parameters applicable to zero or more pictures.

A picture includes a block of luminance (i.e., luma or Y) samples and two blocks of chrominance (i.e., chroma) samples. For ease of explanation, this disclosure may refer to a two-dimensional array of samples as a sample block. To generate an encoded representation of a picture, video encoder 20 may generate a plurality of coding tree blocks (CTBs) for the picture. In some instances, a treeblock may also be referred to as a largest coding unit (LCU) or a treeblock. Each CTB of the picture may be associated with a luma block and two chroma blocks. The CTB's luma block is a sub-block of the picture's luma block and the CTB's chroma blocks are sub-blocks of the picture's chroma blocks. The CTB's chroma blocks correspond to the same area within the picture as the CTB's luma block. The CTBs of HEVC may be broadly analogous to the macroblocks of previous video coding standards, such as H.264/AVC. However, a CTB is not necessarily limited to a particular size and may include one or more coding units (CUs). Video encoder 20 may use quad-tree partitioning to partition the sample blocks associated with a CTB into sample blocks associated with CUs, hence the name “coding tree blocks.”

The CTBs of a picture may be grouped into one or more slices. In some examples, each of the slices includes an integer number of CTBs. As part of encoding a picture, video encoder 20 may generate encoded representations of each slice of the picture (i.e., coded slices). To generate a coded slice, video encoder 20 may encode each CTB of the slice to generate encoded representations of each of the CTBs of the slice (i.e., coded CTBs).

To generate a coded CTB, video encoder 20 may recursively perform quad-tree partitioning on the sample blocks associated with a CTB to divide the sample blocks into progressively-smaller sample blocks. A CU of a CTB may be associated with a luma sample block and two chroma sample blocks. The CU's luma sample block may be a sub-block of the CTB's luma sample block and the CU's chroma sample blocks may be sub-blocks of the CTB's chroma sample blocks. The CU's luma sample block and chroma sample blocks may correspond to a same area within a picture. A partitioned CU may be a CU whose sample blocks are partitioned into sample blocks associated with other CUs. A non-partitioned CU may be a CU whose sample blocks are not partitioned into sample blocks associated with other CUs.

Video encoder 20 may generate one or more prediction units (PUs) for each non-partitioned CU. Each of the PUs of a CU may correspond to an area of a picture within the area of the picture that corresponds to the CU. Video encoder 20 may generate predictive sample blocks for each PU of the CU. The predictive sample blocks of a PU may be blocks of samples. Video encoder 20 may process the PUs in various coding orders, such as a raster scan order or a z-scan order.

Video encoder 20 may use intra prediction or inter prediction to generate the predictive sample blocks for a PU. If video encoder 20 uses intra prediction to generate the predictive sample blocks of a PU, video encoder 20 may generate the predictive sample blocks of the PU based on decoded pixels of the picture associated with the PU. If video encoder 20 uses inter prediction to generate the predictive sample blocks of the PU, video encoder 20 may generate the predictive sample blocks of the PU based on decoded pixels of one or more pictures other than the picture associated with the PU.

Video encoder 20 may generate residual blocks for a CU based on predictive sample blocks of the PUs of the CU. The residual sample blocks for the CU may indicate differences between samples in the predictive sample blocks for the PUs of the CU and corresponding samples in the original sample blocks of the CU.

Furthermore, as part of encoding a non-partitioned CU, video encoder 20 may perform recursive quad-tree partitioning on the residual sample blocks of the CU to partition the residual sample blocks of the CU into one or more smaller residual sample blocks associated with transform units (TUs) of the CU. Each of the TUs may be associated with a residual sample block of luma samples and two residual sample blocks of chroma samples.

Video encoder 20 may apply one or more transforms to the residual sample blocks associated with the TUs to generate coefficient blocks (i.e., blocks of coefficients). Video encoder 20 may perform a quantization process on each of the coefficient blocks. Quantization generally refers to a process in which coefficients are quantized to possibly reduce the amount of data used to represent the coefficients, providing further compression. After video encoder 20 quantizes a coefficient block, video encoder 20 may perform an entropy encoding operation on the coefficient block. For example, video encoder 20 may perform Context-Adaptive Binary Arithmetic Coding (CABAC) on data in the coefficient blocks. Video encoder 20 may output a bitstream that includes an encoded version of the video data.

Video decoder 30 receives the bitstream generated by video encoder 20. In addition, video decoder 30 parses the bitstream to extract syntax elements from the bitstream. Video decoder 30 reconstructs the pictures of the video data based on the syntax elements extracted from the bitstream. The process to reconstruct the video data based on the syntax elements may be generally reciprocal to the process performed by video encoder 20 to generate the syntax elements.

Video decoder 30 generates predictive sample blocks for the PUs of a CU based at least in part on the syntax elements associated with the CU. Video decoder 30 may process the PUs of the CU in various orders, including a raster scan order or a z-scan order. In addition, video decoder 30 may inverse quantize coefficient blocks associated with TUs of the CU. Video decoder 30 may perform inverse transforms on the coefficient blocks to reconstruct residual sample blocks associated with the TUs of the CU. Video decoder 30 may reconstruct the sample blocks of the CU based on the predictive sample blocks and the residual sample blocks.

As described above, video encoder 20 may use inter prediction to generate predictive video blocks and motion information for the PUs of a CU. The motion information of a PU may include one or more motion vectors, one or more reference picture indexes, and a prediction direction indicator. The prediction direction indicates the reference picture list, i.e., List 0 or List 1, in which the reference picture identified by the reference picture index resides. In many instances, the motion information of a given PU is likely to be the same or similar to the motion information of one or more nearby PUs (i.e., PUs that correspond to areas that are spatially or temporally nearby to the area associated with the given PU). Because nearby PUs frequently have similar motion information, video encoder 20 may signal the motion information of a given PU with reference to the motion information of another PU. Signaling the motion information of the given PU with reference to the motion information of the other PU may reduce the number of bits required to indicate the motion information of the given PU.

In some instances, video encoder 20 may signal that the motion information of a given PU is the same as the motion information of another PU. Signaling the motion information of the given PU in this way may be referred to as signaling the motion information of the given PU using “merge/skip mode.” In particular, in merge/skip mode, the motion information for the PU may include a motion vector, reference picture index, and prediction direction of the other PU as a selected MV candidate. In merge mode, video encoder 20 signals one or more TUs for the CU associated with the given PU. In skip mode, video encoder 20 does not signal any TUs for the CU associated with the given PU. Rather, in skip mode, video decoder 30 may assume that all samples in the residual sample blocks of the CU have values equal to zero.

In other instances, video encoder 20 may signal the motion information of a given PU by identifying another PU and indicating a difference between a motion vector of the given PU and a motion vector of the other PU. In addition, in contrast to merge/skip mode in which all motion information is the same, the same or different reference picture index and prediction direction may be signaled. Signaling the motion information of the given PU in this way may be referred to as signaling the motion information of the given PU using advanced motion vector prediction (AMVP) mode. Video encoder 20 may use merge/skip mode or AMVP mode to signal the motion information of PUs in both P and B slices.

To encode the motion information of a PU using merge/skip mode or AMVP mode, video encoder 20 may generate a “MV candidate list” for the PU. The MV candidate list for the PU may include a set of motion vector (MV) candidates. Each of the MV candidates may be a PU other than the PU that video encoder 20 is encoding. For instance, the MV candidate list of a PU may include MV candidates that are PUs whose video blocks are below and to the left, to the left, to the above-left, above, or above and to the right of the video block of the PU. In addition, the MV candidate list may include one or more temporal MV candidates. The temporal MV candidates may be PUs in pictures other than the picture that is currently being coded.

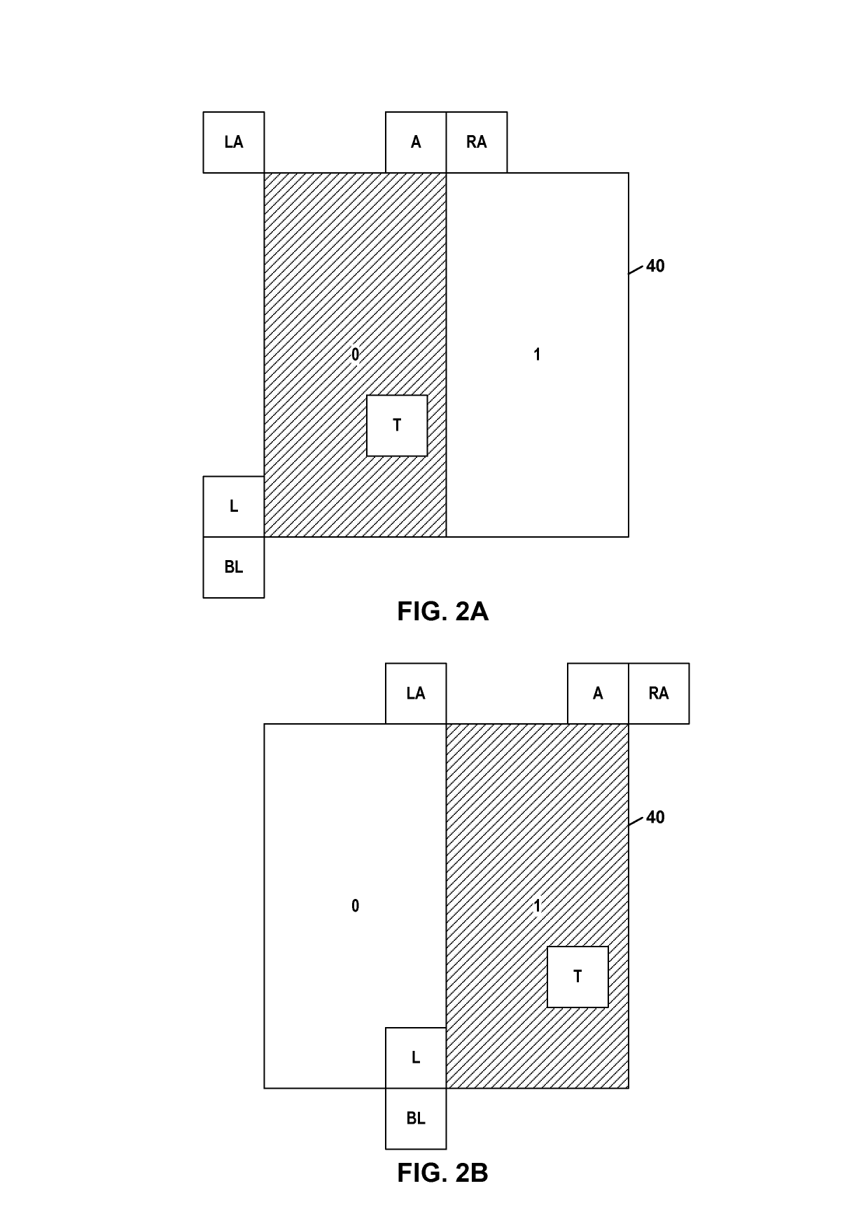

FIGS. 2A and 2B are conceptual diagrams illustrating example locations covered by MV candidates in the MV candidate lists of PUs of a CU 40. In the example of FIG. 2A, the MV candidates in the MV candidate list for PU_0 are PUs covering the locations labeled BL, L, LA, A, RA, and T. The location labeled T indicates a location, in a different temporal picture than the current picture, that corresponds to a location of PU_0. That is, a temporal motion vector predictor (TMVP) candidate is depicted as T. The MV candidate cover the other locations are spatial MV candidates. Similarly, in the example of FIG. 2B, the MV candidates in the MV candidate list for PU_1 are PUs covering the locations labeled BL, LA, A, RA, and T. The MV candidate covering position L is excluded from the MV candidate list for PU_1.

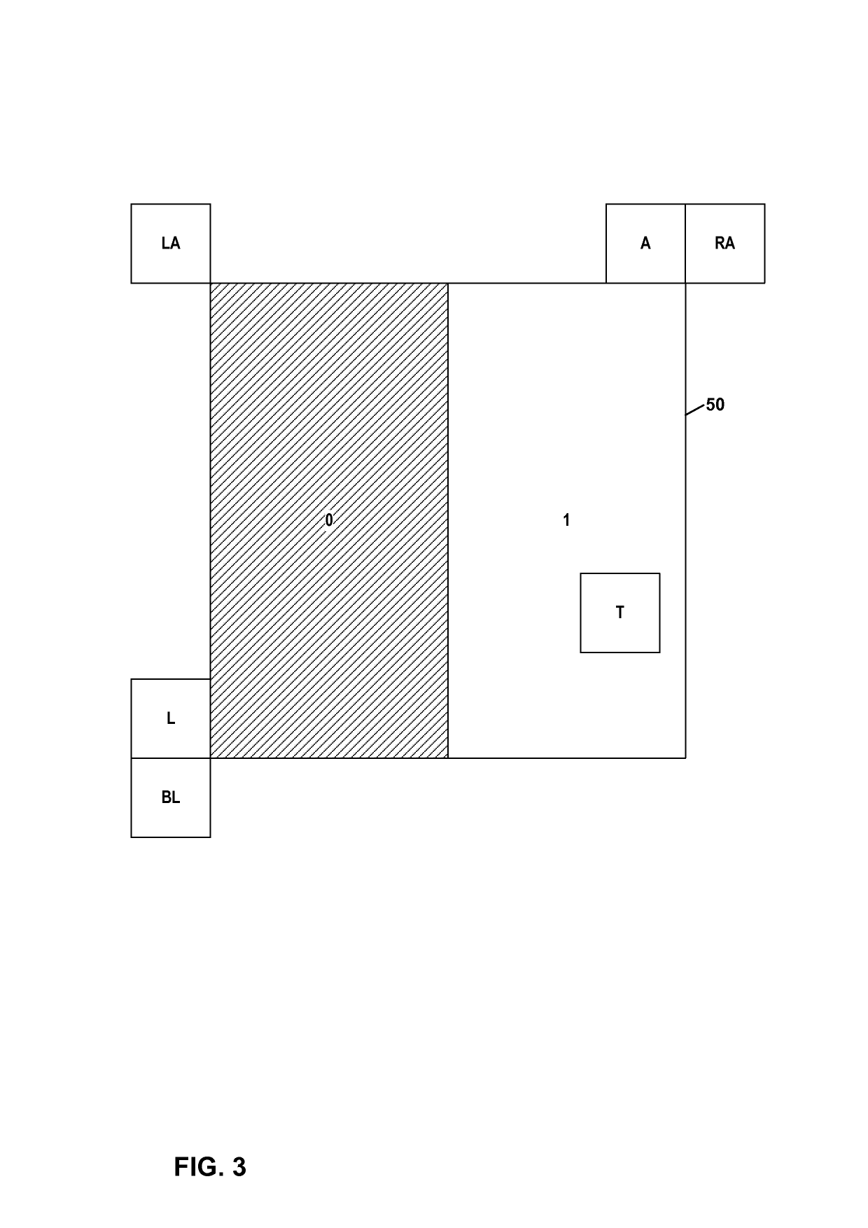

The scheme illustrated in FIGS. 2A and 2B requires video encoder 20 and video decoder 30 to generate different MV candidate lists for different PUs of a CU. This may increase the complexity of video encoder 20 and video decoder 30. To reduce the complexity of video encoder 20 and video decoder 30, video encoder 20 and video decoder 30 may generate a single (i.e., one common) MV candidate list for a CU and may use the single MV candidate list for merge/skip mode in all PUs of the CU. The use of a single MV candidate list for all PUs of the CU may further take into account other neighbor MV candidates so that the MV candidate locations used in generating the common MV candidate list are more balanced among partition modes. With one common MV candidate list used for every PU inside a CU, the candidate index signaling for each PU may be unchanged relative to what is specified in HEVC Working Draft 6. For instance, the candidate index signaling scheme may be the same for every PU. Depending on the maximum allowed number of candidates (e.g., MaxNumMergeCand) specified (i.e., the size of the MV candidate list), truncated unary codewords may be used to represent candidate indexes. The maximum codeword value cMax of the unary codewords may be set to MaxNumMergeCand−1. However, the use of a single MV candidate list for all PUs of a CU may degrade coding efficiency because, in some partitioning modes such as 2N×N, N×2N, and N×N, the sample blocks of the MV candidates may be spatially further from the sample blocks of PUs of the CU. For instance, the MV candidate positions shown in FIG. 3 may work well for the 2N×2N partitioning mode, but may not work as well for other partitioning modes, such as 2N×N, N×2N, and N×N. FIG. 3 is a conceptual diagram illustrating example locations covered by MV candidates in a single MV candidate list for a CU 50.

The number of MV candidates in the MV candidate list for a PU may be limited. For example, if video encoder 20 signals the motion information of a PU using merge/skip mode, the number of MV candidates in the MV candidate list may be limited to five. If video encoder 20 signals the motion information of a PU using AMVP mode, the number of MV candidates in the MV candidate list may be limited to two. In some examples, the variable MaxNumMergeCand may be determined to indicate the maximum number of MV candidates in a MV candidate list for merge/skip mode. In some examples, the maximum number of MV candidates for merge/skip mode is signaled at a slice header.

After generating a MV candidate list for a PU, video encoder 20 may select one of the MV candidates from the MV candidate list. The MV candidate may be selected, for example, based on a rate-distortion metric that evaluates the distortion produced in the reconstructed sample blocks, versus the original sample blocks of the PU, and the amount coding bits required to code the PU. The selected MV candidate is associated with a given MV candidate index. The given MV candidate index indicates that the selected MV candidate occurs at a particular position within the MV candidate list. Video encoder 20 may then identify a codeword associated with the given MV candidate index. The codeword may be a truncated unary codeword. Each truncated unary codeword aside from a greatest allowable truncated unary codeword includes a series of zero or more symbols belonging to a first symbol type (e.g., 1) followed by a terminal symbol belonging to a second symbol type (e.g., 0). The greatest allowable truncated unary codeword may include a series of symbols belonging to the first symbol type and does not include a terminal symbol belonging to the second symbol type. After identifying the codeword, video encoder 20 may entropy encode the codeword. Video encoder 20 may output the entropy encoded codeword in the bitstream.

The maximum number of bits in the codeword may depend on the number of MV candidates in the MV candidate list. For example, assume that the maximum number of MV candidates in a MV candidate list is equal to five. In this example, video encoder 20 may use Table 1, below, to identify codewords associated with MV candidate indexes. In other words, assuming that MaxNumMergeCand is set to 5, the following unary codeword Table 1 may be used for signaling candidate indexes.

TABLE 1
unary codewords with the maximum number of
MV candidates equal to 5

| MV Candidate | |
|---|---|
| Index | Codeword |
| 0 | 0 |
| 1 | 10 |
| 2 | 110 |
| 3 | 1110 |
| 4 | 1111 |

In another example, if the maximum number of MV candidates in the MV candidate list is equal to four, video encoder 20 may use Table 2, below, to identify codewords associated with MV candidate indexes. In other words, if MaxNumMergeCand is set to 4, the following unary codeword Table 2 may be used.

TABLE 2
unary codewords with the maximum number of
MV candidates equal to 4

| MV Candidate | |
|---|---|
| Index | Codeword |
| 0 | 0 |
| 1 | 10 |
| 2 | 110 |
| 3 | 111 |

It can be seen from both Table 1 and Table 2 that the smaller MV candidate indexes generally correspond to shorter truncated unary codewords.

Video decoder 30 may generate the MV candidate list of a PU. Furthermore, video decoder 30 may receive and entropy decode a codeword associated with a MV candidate index of a PU. After entropy decoding the codeword, video decoder 30 uses the codeword to determine the MV candidate index associated with the codeword. After generating the MV candidate list and determining the MV candidate index, video decoder 30 may identify, based on the MV candidate index, an MV candidate in the MV candidate list. Video decoder 30 may then determine the motion information of the PU based on the identified MV candidate.

A CU may have multiple PUs. The PUs may be sequenced according to a particular coding order. Video encoder 20 may generate MV candidate lists for the PUs according to the particular coding order. For example, video encoder 20 may generate a MV candidate list for a first one of the PUs, then a second one of the PUs, and so on. After generating the MV candidate list for a PU, video encoder 20 may select an MV candidate from the MV candidate list and entropy encode a codeword associated with a candidate index of the selected MV candidate. Video encoder 20 may then output the entropy-encoded codeword in the bitstream. In this way, video encoder 20 may signal the candidate indexes of the selected MV candidates for respective PUs. In addition, if video encoder 20 is using AMVP mode, video encoder 20 may output one or more coded motion vector differences (MVDs), one or more reference picture indexes, and a prediction direction indicator. Each of the MVDs may indicate a difference between a motion vector of the PU and a motion vector of the selected MV candidate.

In the above-mentioned schemes where a video coder (e.g., video encoder 20 or video decoder 30) generates one common MV candidate list that is shared among different PUs in a same CU, video encoder 20 signals the MV candidate indexes of each PU independently. The techniques of this disclosure may improve such signaling schemes by taking account of the correlations among MV candidate indexes from different PUs. For example, if a CU has multiple PUs, it is unlikely that all of the PUs are associated with the same MV candidate in merge/skip mode, because such a case may be handled more efficiently in a partitioning mode with a larger PU. As shown in FIG. 3, if video encoder 20 selects the MV candidate L for the first PU (i.e. PU_0) in merge/skip mode, video encoder 20 is unlikely to select the MV candidate L for the second PU (i.e. PU_1) in merge/skip mode. Otherwise, it may be more efficient for CU 50 to have a single 2N×2N PU that uses the MV candidate covering location L in merge/skip mode. This correlation among MV candidate indexes may be used in the techniques of this disclosure to improve the efficiency of the MV candidate index signaling.

In accordance with the techniques of this disclosure, when there is more than one PU in a CU, video encoder 20 may signal the MV candidate index for a later PU of a CU in a manner that is dependent on the MV candidate index(es) of previous PU(s) of the CU. For instance, if a previous PU of a CU is coded with merge/skip mode, video encoder 20 conditionally excludes the MV candidate selected for the previous PU from the MV candidate list used for a current PU of the CU. As a result, the number of MV candidates in the MV candidate list for the current PU is reduced. The MV candidate indexes assigned to the remaining MV candidates are also adjusted accordingly.

To generate the MV candidate lists for the PUs of a CU, video encoder 20 may first generate a single MV candidate list for the CU. The MV candidates in the MV candidate list for the CU may include spatially neighboring PUs whose video blocks occur outside the video block of the CU and a temporal PU whose video block is spatially co-located with the video block of the CU, but is in a different picture in the temporal sequence.

The MV candidate list of the first PU of the CU may be the same as the MV candidate list of the CU. The MV candidate lists of each later PU of the CU may be the same as the MV candidate list of the immediately-previous PU, except that the MV candidate list of the later PU does not include the MV candidates selected for any of the earlier PUs. Because the MV candidate lists for later PUs may exclude one or more MV candidates, the maximum number of MV candidates in the MV candidate lists may progressively decrease for progressively later PUs of the CU. Accordingly, there may be progressively fewer MV candidate indexes. Because there are fewer MV candidate indexes for the MV candidate lists of later PUs of the CU, fewer codewords may be required to represent the MV candidate indexes of later PUs.

Because fewer codewords are required to represent the MV candidate indexes of the MV candidate list of a later PU, the maximum number of bits required to represent the codewords may be less. In other words, a maximum number of bits used to signal indexes of any of the MV candidates in the MV candidate list of a later PU is less than a maximum number of bits used to signal indexes of any of the MV candidates in the MV candidate list of an earlier PU.

In the example of FIG. 3, the MV candidate list and the associated candidate indexes and codewords shown in Table 3 may be used for PU_0, assuming that the maximum number of MV candidates (e.g., MaxNumMergeCand) is equal to 5 and the candidates in the list are labeled as A, B, C, D, and E. The index signaling for PU_0 may be unchanged from that of HEVC Working Draft 6.

TABLE 3
Index and codeword assignment for PU_0

| MV | MV | |
|---|---|---|
| Candidate | Candidate | |
| List | Index | Codeword |
| Candidate A | 0 | 0 |
| Candidate B | 1 | 10 |
| Candidate C | 2 | 110 |
| Candidate D | 3 | 1110 |
| Candidate E | 4 | 1111 |

Candidates A through E may correspond to MV candidates covering locations BL, L, LA, A, RA, or T in FIG. 3. Assume that PU_0 is coded in merge/skip mode and also assume that video encoder 20 selects candidate C for PU_0. In this case, based on the techniques of this disclosure, the MV candidate list for PU_1 and the associated candidate indexes and codewords are shown in Table 4, below.

TABLE 4
Index and codeword assignment for PU_1

| MV | MV | |
|---|---|---|
| Candidate | Candidate | |
| List | Index | Codeword |
| Candidate A | 0 | 0 |
| Candidate B | 1 | 10 |
| Candidate D | 2 | 110 |
| Candidate E | 3 | 111 |

It can be seen in Table 4 that MV candidate C is excluded from the MV candidate list of PU_1. In addition, it can be seen that the number of MV candidates in the MV candidate list for PU_1 decreases from five to four, and MV candidate index signaling is changed accordingly. Because MV candidate C is very unlikely to be chosen for PU_1 after having been chosen for PU_0, excluding MV candidate C from the MV candidate list for PU_1 may make the index signaling of MV candidates D and E more efficient for PU_1. If PU_0 is not in merge/skip mode, no MV candidate is excluded from the MV candidate list for PU_1 and the candidate index and codeword list of Table 3 may be used for PU_1.

The use of N×2N partitioning shown in FIGS. 2A, 2B, and 3 is merely an example. The techniques of this disclosure may also be applicable to other partitioning modes, such as 2N×N, N×N, 2N×nU, 2N×nD, nL×2N and nR×2N, etc. In accordance with the techniques of this disclosure, if a previous PU in a same CU has merge mode, and if a current PU selecting the same MV candidate used for the previous PU could result in a partition mode with larger partitions, the MV candidate selected for the previous PU may be excluded from the candidate list used for the current PU. Additionally, index signaling may be changed accordingly based on the reduced number of available merge candidates for the current PU.

In this way, video encoder 20 may encode a CU having a first PU and a second PU. To encode the CU, video encoder 20 may generate a first MV candidate list, the first MV candidate list including a plurality of MV candidates. Video encoder 20 may select, from the first MV candidate list, a MV candidate for the first PU. In addition, video encoder 20 may generate a second MV candidate list, the second MV candidate list including each of the MV candidates in the first MV candidate list except the MV candidate selected for the first PU. Video encoder 20 may select, from the second MV candidate list, a MV candidate for the second PU. In some examples where video encoder 20 signals the motion information for the first and second PUs using AMVP mode, video encoder 20 may signal a MVD for the first PU and a MVD for the second PU.

Similarly, video decoder 30 may generate a first MV candidate list, the first MV candidate list including a plurality of MV candidates. Video decoder 30 may signal the motion information of first PU and the motion information of the second PU using merge/skip mode or AMVP mode. In such examples, video decoder 30 may generate, based in part on motion information of a selected MV candidate in the first MV candidate list, predictive sample blocks for a first PU of a CU. In addition, video decoder 30 may generate a second MV candidate list. The second MV candidate list includes each MV candidate in the first MV candidate list but excludes the selected MV candidate in the first MV candidate list. Video decoder 30 may generate, based in part on motion information of a MV candidate in the second MV candidate list, predictive sample blocks for a second PU of the CU. Video decoder 30 may generate, based in part on the predictive sample blocks of the first and second PUs, a sample block of the CU.

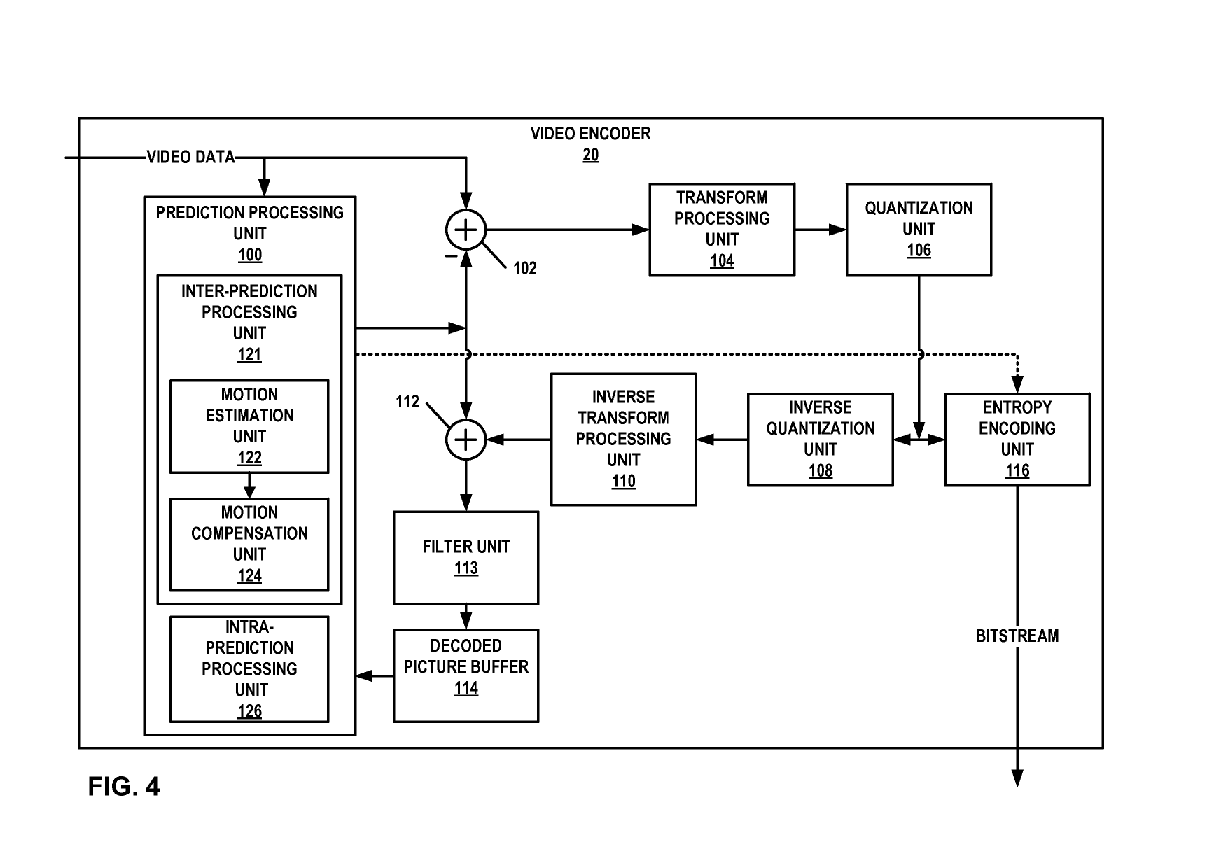

FIG. 4 is a block diagram illustrating an example video encoder 20 that is configured to implement the techniques of this disclosure. FIG. 4 is provided for purposes of explanation and should not be considered limiting of the techniques as broadly exemplified and described in this disclosure. For purposes of explanation, this disclosure describes video encoder 20 in the context of HEVC coding. However, the techniques of this disclosure may be applicable to other coding standards or methods.

In the example of FIG. 4, video encoder 20 includes a prediction processing unit 100, a residual generation unit 102, a transform processing unit 104, a quantization unit 106, an inverse quantization unit 108, an inverse transform processing unit 110, a reconstruction unit 112, a filter unit 113, a decoded picture buffer 114, and an entropy encoding unit 116. Prediction processing unit 100 includes an inter-prediction processing unit 121 and an intra-prediction processing unit 126. Inter-prediction processing unit 121 includes a motion estimation unit 122 and a motion compensation unit 124. In other examples, video encoder 20 may include more, fewer, or different functional components.

Video encoder 20 may receive video data. To encode the video data, video encoder 20 may encode each slice of each picture of the video data. As part of encoding a slice, video encoder 20 may encode each CTB in the slice. As part of encoding a CTB, prediction processing unit 100 may perform quad-tree partitioning on the sample blocks associated with the CTB to divide the sample blocks into progressively-smaller sample blocks. The smaller sample blocks may be associated with CUs. For example, prediction processing unit 100 may partition the sample blocks of a CTB into four equally-sized sub-blocks, partition one or more of the sub-blocks into four equally-sized sub-sub-blocks, and so on.

Video encoder 20 may encode CUs of a CTB to generate encoded representations of the CUs (i.e., coded CUs). As part of encoding a CU, prediction processing unit 100 may partition the sample blocks of the CU among one or more PUs of the CU. Video encoder 20 and video decoder 30 may support various PU sizes. Assuming that the size of a particular CU is 2N×2N, video encoder 20 and video decoder 30 may support PU sizes of 2N×2N or N×N for intra prediction, and symmetric PU sizes of 2N×2N, 2N×N, N×2N, N×N, or similar for inter prediction. Video encoder 20 and video decoder 30 may also support asymmetric partitioning for PU sizes of 2N×nU, 2N×nD, nL×2N, and nR×2N for inter prediction.

Inter-prediction processing unit 121 may generate predictive data for a PU by performing inter prediction on each PU of a CU. The predictive data for the PU may include predictive sample blocks that corresponds to the PU and motion information for the PU. Slices may be I slices, P slices, or B slices. Inter-prediction unit 121 may perform different operations for a PU of a CU depending on whether the PU is in an I slice, a P slice, or a B slice. In an I slice, all PUs are intra predicted. Hence, if the PU is in an I slice, inter-prediction unit 121 does not perform inter prediction on the PU.

If a PU is in a P slice, motion estimation unit 122 may search the reference pictures in a list of reference pictures (e.g., “list 0”) for a reference block for the PU. The reference blocks of the PU may be a set of sample blocks that correspond to a same area of a reference picture and that most closely corresponds to the sample blocks of the PU. Motion estimation unit 122 may generate a reference picture index that indicates the reference picture in list 0 containing the reference block of the PU and a motion vector that indicates a spatial displacement between the luma block of the PU and the reference block. Motion estimation unit 122 may output the reference picture index and the motion vector as the motion information of the PU. Motion compensation unit 124 may generate the predictive sample blocks of the PU based on the reference blocks indicated by the motion information of the PU.

If a PU is in a B slice, motion estimation unit 122 may perform uni-directional inter prediction or bi-directional inter prediction for the PU. To perform uni-directional inter prediction for the PU, motion estimation unit 122 may search the reference pictures of a first reference picture list (“list 0”) or a second reference picture list (“list 1”) for a reference block for the PU. Motion estimation unit 122 may output, as the motion information of the PU, a reference picture index that indicates a position in list 0 or list 1 of the reference picture that contains the reference blocks, a motion vector that indicates a spatial displacement between the sample blocks of the PU and the reference blocks, and a prediction direction indicator that indicates whether the reference picture is in list 0 or list 1.

To perform bi-directional inter prediction for a PU, motion estimation unit 122 may search the reference pictures in list 0 for a reference block for the PU and may also search the reference pictures in list 1 for another reference block for the PU. Motion estimation unit 122 may generate reference picture indexes that indicate positions in list 0 and list 1 of the reference pictures that contain the reference blocks. In addition, motion estimation unit 122 may generate motion vectors that indicate spatial displacements between the reference blocks and the sample blocks of the PU. The motion information of the PU may include the reference picture indexes and the motion vectors of the PU. Motion compensation unit 124 may generate the predictive sample blocks of the PU based on the reference blocks indicated by the motion information of the PU.

In some instances, motion estimation unit 122 does not output a full set of motion information for a PU to entropy encoding module 116. Rather, motion estimation unit 122 may signal the motion information of a PU with reference to the motion information of another PU. For example, motion estimation unit 122 may determine that the motion information of the PU is sufficiently similar to the motion information of a neighboring PU. In this example, motion estimation unit 122 may include in the PU a value that indicates to video decoder 30 that the PU has the same motion information as the neighboring PU or has motion information that can be derived from neighboring PUs. In another example, motion estimation unit 122 may indicate in the PU a MV candidate index of a MV candidate and a motion vector difference (MVD). The MVD indicates a difference between the motion vector of the PU and the motion vector of the indicated MV candidate. Video decoder 30 may use the motion vector of the indicated MV candidate and the MVD to determine the motion vector of the PU. By referring to the motion information of a MV candidate when signaling the motion information of a PU (i.e., by using merge/skip mode or AMVP mode), video encoder 20 may be able to signal the motion information of the PU using fewer bits.

Inter prediction processing unit 121 may generate MV candidate lists for each PU of a CU. The MV candidate list for a first PU of the CU (i.e., a first MV candidate list) may include a plurality of MV candidates, each of which cover locations outside the CU. In accordance with the techniques of this disclosure, MV candidate lists for subsequent PUs of the CU may include each MV candidate of a MV candidate list for an immediately-previous (in coding order) PU of the CU, except for a selected MV candidate in the MV candidate list for the immediately-previous PU.

Intra-prediction processing unit 126 may generate predictive data for a PU by performing intra prediction on the PU. The predictive data for the PU may include predictive sample blocks for the PU and various syntax elements. Intra-prediction processing unit 126 may perform intra prediction on PUs in I slices, P slices, and B slices.

To perform intra prediction on a PU, intra-prediction processing unit 126 may use multiple intra prediction modes to generate multiple sets of predictive data for the PU. To use an intra prediction mode to generate a set of predictive data for the PU, intra-prediction processing unit 126 may extend samples from sample blocks of neighboring PUs across the sample blocks of the PU in a direction associated with the intra prediction mode. The neighboring PUs may be above, above and to the right, above and to the left, or to the left of the PU, assuming a left-to-right, top-to-bottom encoding order for PUs, CUs, and CTBs. Intra-prediction processing unit 126 may use various numbers of intra prediction modes, e.g., 33 directional intra prediction modes. In some examples, the number of intra prediction modes may depend on the sizes of the sample blocks of the PU.

Prediction processing unit 100 may select the predictive data for PUs of a CU from among the predictive data generated by inter-prediction processing unit 121 for the PUs or the predictive data generated by intra-prediction processing unit 126 for the PUs. In some examples, prediction processing unit 100 selects the predictive data for the PUs of the CU based on rate/distortion metrics of the sets of predictive data. The predictive sample blocks of the selected predictive data may be referred to herein as the selected predictive sample blocks.

Residual generation unit 102 may generate, based on the sample blocks of a CU and the selected predictive sample blocks of the PUs of the CU, residual sample blocks of a CU. For instance, residual generation unit 102 may generate the residual sample blocks of the CU such that each sample in the residual sample blocks has a value equal to a difference between a sample in a sample blocks of the CU and a corresponding sample in a selected predictive sample block of a PU of the CU.

Transform processing unit 104 may generate a set of one or more TUs for a CU. Each of the TUs of the CU may be associated with a luma residual sample block and two chroma sample blocks. A TU's luma residual sample block may be a sub-block of the CU's luma residual sample block and the TU's chroma residual sample blocks may be sub-blocks of the CU's chroma residual sample blocks. The TU's chroma residual sample blocks correspond to the same area of the picture as the TU's luma residual sample block. Transform processing unit 104 may perform quad-tree partitioning to partition the residual sample blocks of a CU into residual sample blocks associated with the CU's TUs. The sizes and positions of the residual sample blocks associated with TUs of a CU may or may not be based on the sizes and positions of sample blocks of the PUs of the CU.

Transform processing unit 104 may generate coefficient blocks for each TU of a CU by applying one or more transforms to the residual sample blocks associated with the TU. Transform processing unit 104 may apply various transforms to a residual sample block associated with a TU. For example, transform processing unit 104 may apply a discrete cosine transform (DCT), a directional transform, or a conceptually-similar transform to a residual sample block. The transforms may convert the residual sample block from a pixel domain to a frequency domain. Thus, the coefficients in the coefficient block may be said to be at particular frequencies.

Quantization unit 106 may quantize the coefficients in a coefficient block associated with a TU. The quantization process may reduce the bit depth associated with some or all of the coefficients. For example, an n-bit coefficient may be rounded down to an m-bit coefficient during quantization, where n is greater than m. Quantization unit 106 may quantize a coefficient block associated with a TU of a CU based on a quantization parameter (QP) value associated with the CU. Video encoder 20 may adjust the degree of quantization applied to the coefficient blocks associated with a CU by adjusting the QP value associated with the CU.

Inverse quantization unit 108 and inverse transform processing unit 110 may apply inverse quantization and inverse transforms to a coefficient block, respectively, to reconstruct a residual sample block from the coefficient block. Reconstruction unit 112 may add samples of the reconstructed residual sample block to corresponding samples from one or more predictive sample blocks generated by prediction processing unit 100 to produce a reconstructed sample block associated with a TU. By reconstructing sample blocks for each TU of a CU in this way, video encoder 20 may reconstruct the sample blocks of the CU.

Filter unit 113 may perform a deblocking operation to reduce blocking artifacts in the sample blocks of a CU. Decoded picture buffer 114 may store the reconstructed sample blocks. Inter-prediction unit 121 may use a reference picture that contains the reconstructed sample blocks to perform inter prediction on PUs of other pictures. In addition, intra-prediction processing unit 126 may use reconstructed sample blocks in decoded picture buffer 114 to perform intra prediction on other PUs in the same picture as the CU.

Entropy encoding unit 116 may receive data from other functional components of video encoder 20. For example, entropy encoding unit 116 may receive coefficient blocks from quantization unit 106 and may receive syntax elements from prediction processing unit 100. Entropy encoding unit 116 may perform one or more entropy encoding operations on the data to generate entropy-encoded data. For example, entropy encoding unit 116 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. Video encoder 20 may output a bitstream that includes entropy-encoded data generated by entropy encoding unit 116.

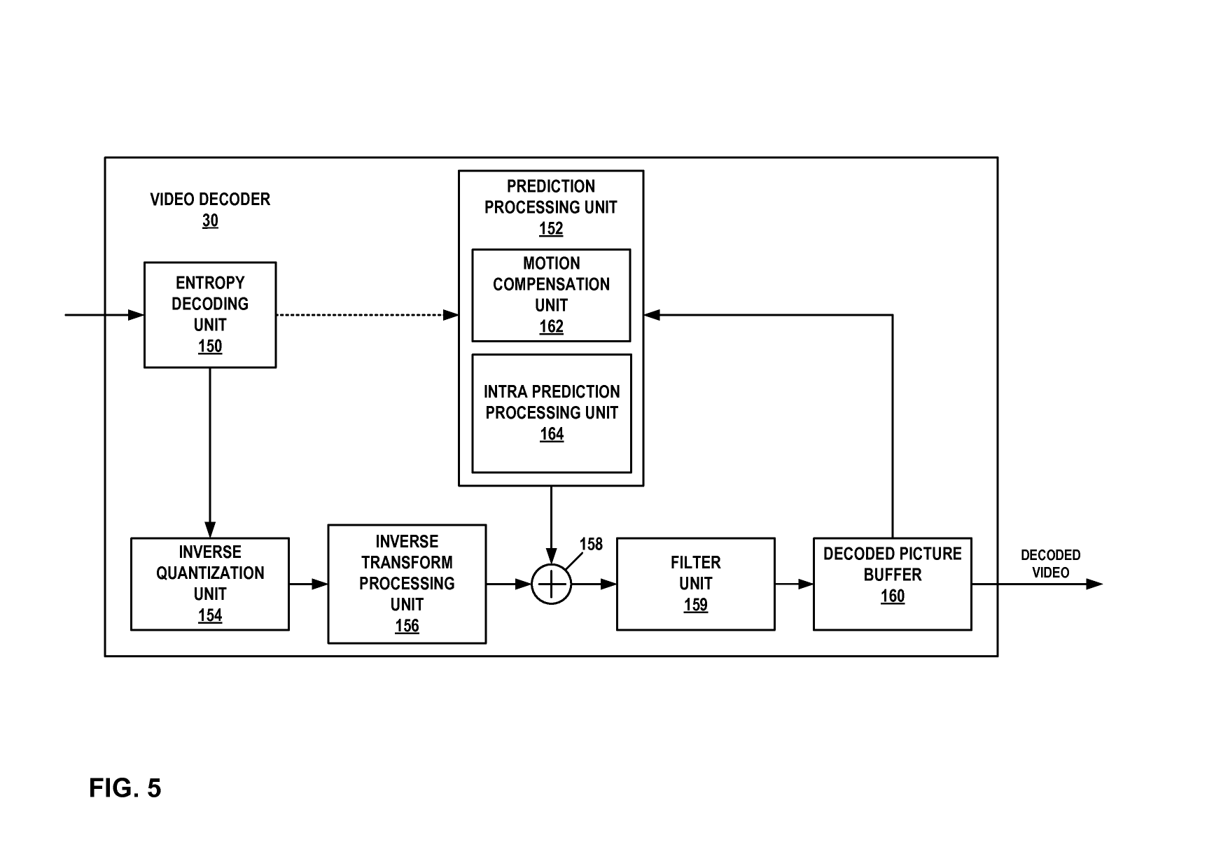

FIG. 5 is a block diagram illustrating an example video decoder 30 that is configured to implement the techniques of this disclosure. FIG. 5 is provided for purposes of explanation and is not limiting on the techniques as broadly exemplified and described in this disclosure. For purposes of explanation, this disclosure describes video decoder 30 in the context of HEVC coding. However, the techniques of this disclosure may be applicable to other coding standards or methods.

In the example of FIG. 5, video decoder 30 includes an entropy decoding unit 150, a prediction processing unit 152, an inverse quantization unit 154, an inverse transform processing unit 156, a reconstruction unit 158, a filter unit 159, and a decoded picture buffer 160. Prediction processing unit 152 includes a motion compensation unit 162 and an intra-prediction processing unit 164. In other examples, video decoder 30 may include more, fewer, or different functional components.

Video decoder 30 may receive a bitstream. Entropy decoding unit 150 may parse the bitstream to extract syntax elements from the bitstream. As part of parsing the bitstream, entropy decoding unit 150 may entropy decode entropy-encoded syntax elements in the bitstream. Prediction processing unit 152, inverse quantization unit 154, inverse transform processing unit 156, reconstruction unit 158, and filter unit 159 may generate decoded video data based on the syntax elements extracted from the bitstream.

The bitstream may comprise a series of NAL units. The NAL units of the bitstream may include coded slice NAL units. As part of parsing the bitstream, entropy decoding unit 150 may extract and entropy decode syntax elements from the coded slice NAL units. Each of the coded slices may include a slice header and slice data. The slice header may contain syntax elements pertaining to a slice.

In addition, video decoder 30 may perform a reconstruction operation on a non-partitioned CU. To perform the reconstruction operation on a non-partitioned CU, video decoder 30 may perform a reconstruction operation on each TU of the CU. By performing the reconstruction operation for each TU of the CU, video decoder 30 may reconstruct residual sample blocks of the CU.

As part of performing a reconstruction operation on a TU of a CU, inverse quantization unit 154 may inverse quantize, i.e., de-quantize, coefficient blocks associated with the TU. Inverse quantization unit 154 may use a QP value associated with the CU of the TU to determine a degree of quantization and, likewise, a degree of inverse quantization for inverse quantization unit 154 to apply.

After inverse quantization unit 154 inverse quantizes a coefficient block, inverse transform processing unit 156 may apply one or more inverse transforms to the coefficient block in order to generate a residual sample block associated with the TU. For example, inverse transform processing unit 156 may apply an inverse DCT, an inverse integer transform, an inverse Karhunen-Loeve transform (KLT), an inverse rotational transform, an inverse directional transform, or another inverse transform to the coefficient block.

If a PU is encoded using intra prediction, intra-prediction processing unit 164 may perform intra prediction to generate predictive sample blocks for the PU. Intra-prediction processing unit 164 may use an intra prediction mode to generate the predictive sample blocks of the PU based on the sample blocks of spatially-neighboring PUs. Intra-prediction processing unit 164 may determine the intra prediction mode for the PU based on one or more syntax elements parsed from the bitstream.

Prediction processing unit 152 may construct a first reference picture list (list 0) and a second reference picture list (list 1) based on syntax elements extracted from the bitstream. Furthermore, if a PU is encoded using inter prediction, prediction processing unit 152 may determine motion information for the PU. Motion compensation unit 162 may determine, based on the motion information of the PU, one or more reference blocks for the PU. Motion compensation unit 162 may generate, based on the one or more reference blocks for the PU, predictive sample blocks for the PU.

Prediction processing unit 152 may determine the motion information of a PU in various ways. For example, prediction processing unit 152 may determine that the motion information of a PU is signaled using merge/skip mode. If the motion information of a PU is signaled using merge/skip mode, entropy decoding unit 150 may parse, from the bitstream, a codeword that corresponds to a MV candidate index of an MV candidate selected for the PU. Furthermore, motion compensation unit 162 may generate a MV candidate list for the PU. Motion compensation unit 162 may determine that the motion information of the PU is equal to the motion information of the MV candidate at the position in the PU's MV candidate list indicated by the PU's MV candidate index.

In accordance with the techniques of this disclosure, if the PU is a first (in coding order) PU of a CU, the PU's MV candidate list may match a MV candidate list used when the CU includes only a single PU. Furthermore, in accordance with the techniques of this disclosure, the MV candidate list for a subsequent (i.e., non-first) PU of a CU may include each MV candidate in the MV candidate list for the immediately-previous PU of the CU, except the immediately-previous PU's selected MV candidate. The MV candidate list may include MV candidates for merge/skip mode or AMVP mode.

Reconstruction unit 158 may use the residual sample blocks of a CU's TUs and the predictive sample blocks of the CU's PUs, i.e., either intra-prediction data or inter-prediction data, as applicable, to reconstruct the CU's sample blocks. In particular, reconstruction unit 158 may add samples of the residual sample blocks to corresponding samples of the predictive sample blocks to reconstruct the CU's sample blocks.

Filter unit 159 may perform a deblocking operation to reduce blocking artifacts associated with the sample blocks of the CU. Video decoder 30 may store the sample blocks of the CU in decoded picture buffer 160. Decoded picture buffer 160 may provide reference pictures for motion compensation, intra prediction, and presentation.

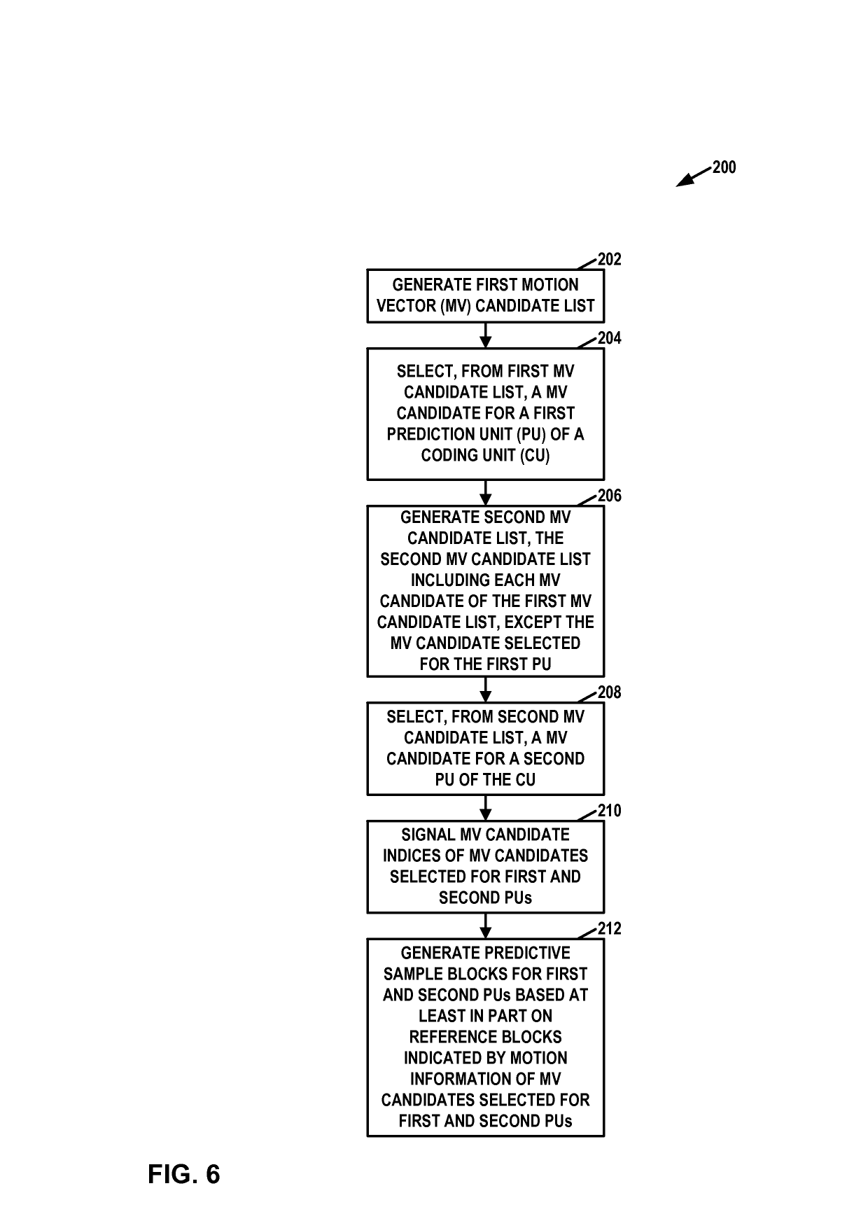

FIG. 6 is a flowchart illustrating an example operation 200 of video encoder 20, in accordance with one or more techniques of this disclosure. By performing operation 200, video encoder 20 may encode a CU that has at least a first PU and a second PU. As illustrated in the example of FIG. 6, video encoder 20 generates a first MV candidate list (202). The first MV candidate list may include a plurality of MV candidates. Furthermore, video encoder 20 may select, from the first MV candidate list, a MV candidate for the first PU (204).

In addition, video encoder 20 generates a second MV candidate list (206). The second MV candidate list includes each of the MV candidates in the first MV candidate list except the MV candidate selected for the first PU. In some examples, the second MV candidate list may consist of each of the MV candidates in the first MV candidate list except the MV candidate selected for the first PU. Video encoder 20 selects, from the second MV candidate list, a MV candidate for the second PU (208).

Video encoder 20 may signal, in a bitstream, the MV candidate indices of the MV candidates selected for the first and second PUs (210). In some examples, a maximum number of bits used to signal indexes of any of the MV candidates in the second MV candidate list is less than a maximum number of bits used to signal indexes any of the MV candidates in the first MV candidate list. In particular, the second MV candidate list excludes the selected MV candidate for the first PU, and is therefore shorter than the first MV candidate list. Furthermore, in some examples, video encoder 20 may signal a codeword that indicates the index of the MV candidate selected for the first PU and a codeword that indicates the index of the MV candidate selected for the second PU. The codewords may be truncated unary codewords. Thus, video encoder 20 may signal a truncated unary codeword that indicates the index of the MV candidate selected for the first PU and may signal a truncated unary codeword that indicates the index of the MV candidate selected for the second PU. The maximum codeword length, i.e., maximum number of bits, in the list of codewords used to signal the second MV codword is shorter than the maximum codeword length in the list of codewords used to signal the first MV codeword.

In some examples, motion compensation unit 124 may generate predictive sample blocks for the first and second PUs based at least in part on reference blocks indicated by motion information of the respective MV candidates selected for the first and second PUs (212). That is, motion compensation unit 124 may generate predictive sample blocks for the first PU based at least in part on reference blocks indicated by motion information of the MV candidate selected for the first PU. In addition, motion compensation unit 124 may generate predictive sample blocks for the second PU based at least in part on reference blocks indicated by motion information of the MV candidate selected for the second PU. If the motion information of the first PU and the second PU is signaled using merge/skip mode, the motion information of the MV candidate selected for the first PU includes a MV that specifies a spatial displacement between a sample block of the first PU and the reference block and the motion information of the MV candidate selected for the second PU includes a MV that specifies a spatial displacement between a sample block of the second PU and the reference block

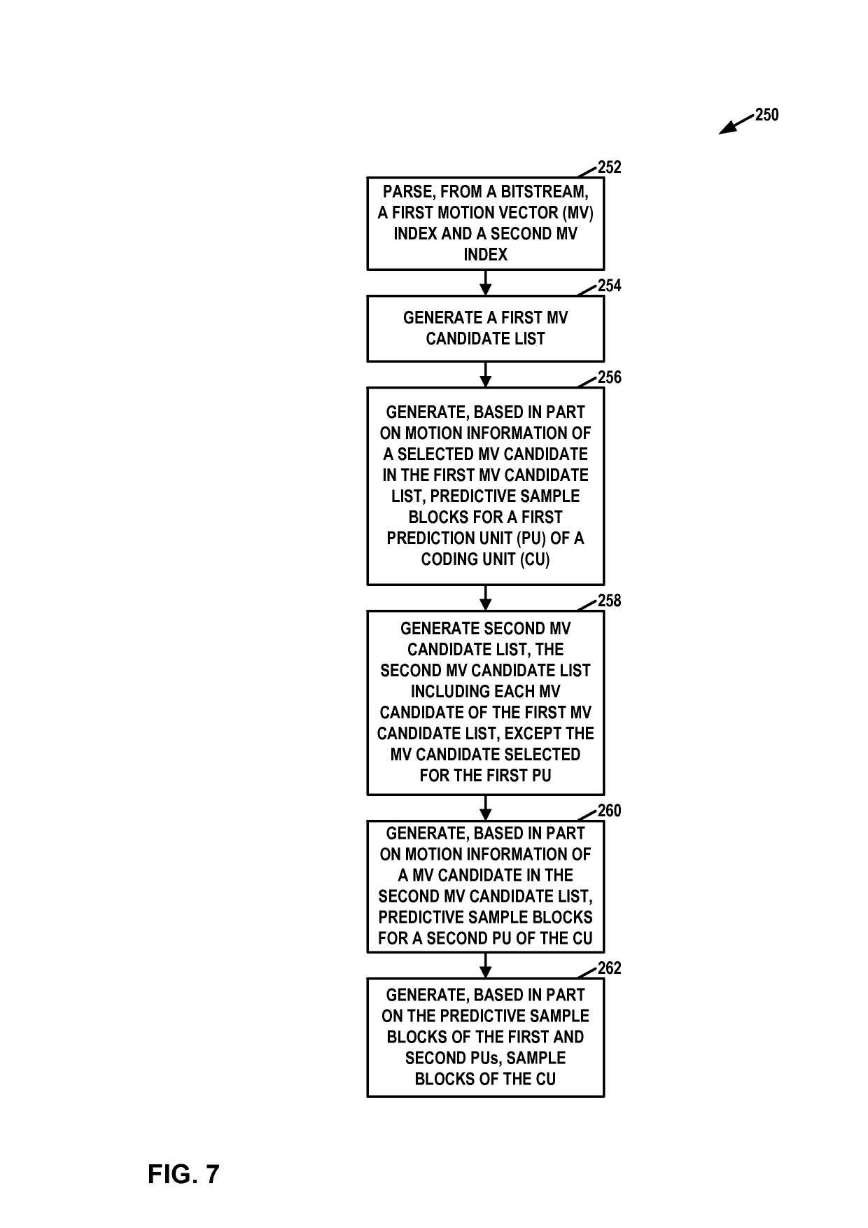

FIG. 7 is a flowchart illustrating an example operation 250 of video decoder 30, in accordance with one or more techniques of this disclosure. The flowcharts of FIGS. 6 and 7 are provided as examples. In other examples, the flowcharts may include more, fewer, or different actions.

As illustrated in the example of FIG. 7, entropy decoding unit 150 of video decoder 30 may parse, from a bitstream, a first MV index and a second MV index (252). In some examples, entropy decoding unit 150 may parse, from the bitstream, truncated unary codewords that indicate the first and second MV indexes. Prediction processing unit 152 of video decoder 30 may generate a first MV candidate list (254). The first MV candidate list includes a plurality of MV candidates. Motion compensation unit 162 of video decoder 30 may generate, based in part on motion information of a selected MV candidate in the first MV candidate list, predictive sample blocks for the first PU (256). In some examples, motion compensation unit 162 determines, based on the first MV index, the selected MV candidate in the first MV candidate list.

In addition, prediction processing unit 152 generates a second MV candidate list (258). The second MV candidate list includes each MV candidate in the first MV candidate list except the selected MV candidate in the first MV candidate list. In some examples, the second MV candidate list may consist of each of the MV candidates in the first MV candidate list except the MV candidate selected for the first PU. Motion compensation unit 162 may generate, based in part on motion information of a MV candidate in the second MV candidate list, predictive sample blocks for a second PU of the CU (260). In some examples, motion compensation unit 162 may determine, based on the second MV index, the selected MV candidate in the second MV candidate list. Reconstruction unit 158 of video decoder 30 may generate, based in part on the predictive sample blocks of the first and second PUs, sample blocks of the CU (262). In some examples where the motion information of the first PU and the motion information of the second PU is signaled using AMVP mode, motion compensation unit 162 may generate, based at least in part on the motion information of the selected MV candidate in the first MV candidate list and a first MVD signaled in the bitstream, the predictive sample block for the first PU. In addition, motion compensation unit 162 may generate, based at least in part on the motion information of the selected MV candidate in the second MV candidate list and a second MVD signaled in the bitstream, the predictive sample block for the second PU.

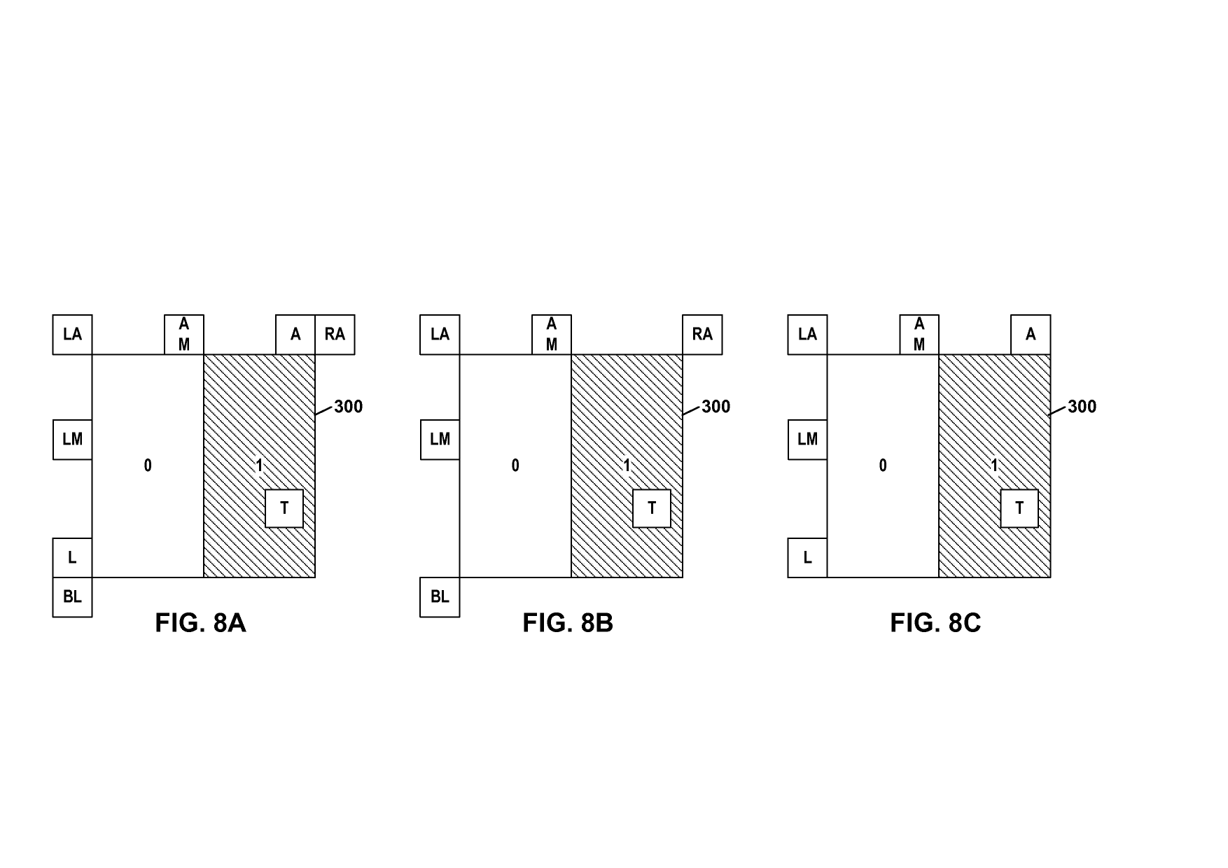

FIGS. 8A, 8B, and 8C are conceptual diagrams illustrating example locations covered by MV candidates. As discussed above, generating a single MV candidate list for a CU and using this MV candidate list for all PUs of the CU may reduce the complexity of video encoder 20 and video decoder 30. However, the use of a single MV candidate list for a CU may degrade coding efficiency. In addition to, or alternatively to the techniques of this disclosure described above, the locations of MV candidates in the MV candidate list for a CU can be modified to take into account other MV candidates so that the locations of the MV candidates are more balanced among different modes of partitioning the CU into PUs.

For example, in FIG. 8A, a video coder (such as video encoder 20 or video decoder 30) may include one or more middle MV candidates in a MV candidate list for a CU 300. The middle MV candidates cover locations labeled LM and AM in FIG. 8A. The locations labeled LM and AM are located at the mid points of the left and top borders of CU 300, respectively. The middle MV candidates may be important for those partition modes other than 2N×2N. Although not shown in FIG. 8A, the video coder may include, in the MV candidate list for CU 300, one or more MV candidates that cover other locations, such as MV locations nearby to LM and AM.

Increasing the number of MV candidates in the MV candidate list for CU 300 may increase the complexity of video encoder 20 and video decoder 30. Accordingly, video encoder 20 and video decoder 30 may omit some of the MV candidates shown in FIG. 8A while keeping one or more of the middle MV candidates (i.e., AM and LM). For example, FIG. 8B omits the “left” MV candidate (i.e., the MV candidate that covers location L in FIG. 8A) and the “above” MV candidate (i.e., the MV candidate that covers location A in FIG. 8A) and includes the middle MV candidates (i.e., the MV candidates that cover locations AM and LM). In another example, FIG. 8C omits the “below left” MV candidate (i.e., the MV candidate that covers location BL in FIG. 8A) and the “right above” MV candidate (i.e., the MV candidate that covers location RA in FIG. 8A) and includes the middle MV candidates.

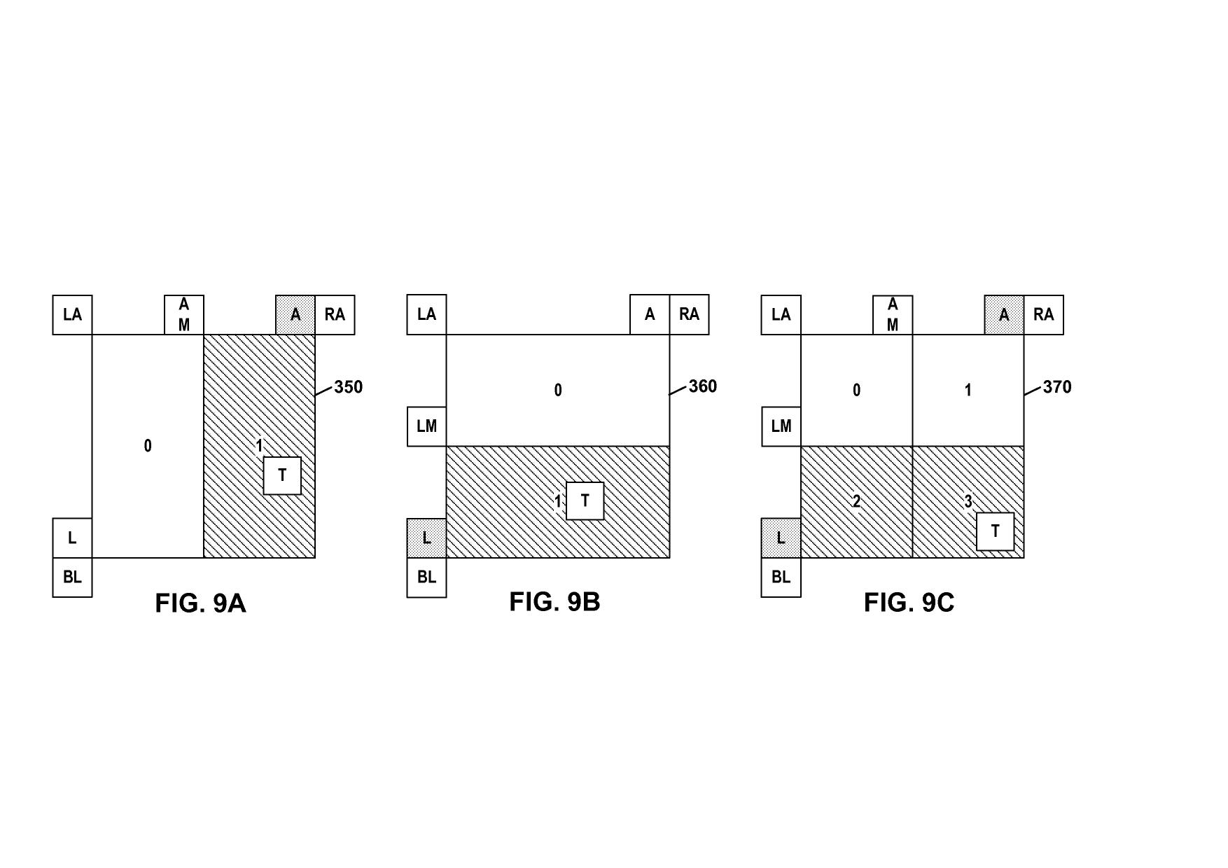

FIGS. 9A-9C are conceptual diagrams illustrating example locations of MV candidates where the locations of the MV candidates are dependent on a partitioning mode of a CU. That is, a video coder (such as video encoder 20 and/or video decoder 30) may generate a single MV candidate list for a CU. However, the MV candidate list may include MV candidates that cover different locations, depending on how the CUs are partitioned into PUs. For example, the video coder may generate different MV candidate lists for a CU depending on whether the CU is partitioned into PUs according to a 2N×N partitioning mode or an N×2N partitioning mode.

In the example of FIG. 9A, a CU 350 is partitioned into PUs according to an N×2N partitioning mode. The block labeled “0” represents a first PU of CU 350 and the block labeled “1” represents a second PU of CU 350. In the example of FIG. 9A, the video coder may generate a MV candidate list for CU 350 that includes MV candidates that cover locations BL, L, LA, AM, RA, and T. To prevent there from being more than five spatial MV candidates in the MV candidate list for CU 350, the video coder may omit from the MV candidate list an MV candidate that covers location A. In some examples, the MV candidate list used for the first PU of CU 350 may include MV candidates that cover locations BL, L, LA, AM, RA, and T. In this way, the above-middle candidate AM can be added to replace the above candidate A and/or the above-right candidate RA, as shown in FIG. 9A. The MV candidate list for the second PU of CU 350 may be the same as the MV candidate list for the first PU of CU 350, except the MV candidate list for the second PU does not include the selected MV candidate for the first PU.

In the example of FIG. 9B, a CU 360 is partitioned into PUs according to a 2N×N partitioning mode. The block labeled “0” represents a first PU of CU 360 and the block labeled “1” represents a second PU of CU 360. In the example of FIG. 9B, the video coder may generate a MV candidate list for CU 360 that includes MV candidates that cover locations B, LM, LA, A, RA, and T. To prevent there from being more than five spatial MV candidates in the MV candidate list for CU 360, the video coder may omit from the MV candidate list an MV candidate that covers location L. In this way, the left-middle candidate LM can be added to replace the left candidate L and/or the below-left candidate BL, as shown in FIG. 9B. In some examples, the MV candidate list used for the first PU of CU 350 may include MV candidates that cover locations BL, LM, LA, A, RA, and T. The MV candidate list for the second PU of CU 350 may be the same as the MV candidate list for the first PU of CU 350, except the MV candidate list for the second PU does not include the selected MV candidate for the first PU.

In the example of FIG. 9C, a CU 370 is partitioned into PUs according to an N×N partitioning mode. The blocks labeled “0,” “1,” “2,” and “3” represent PUs of CU 370. In the example of FIG. 9C, the video coder may generate a MV candidate list for CU 370 that includes MV candidates that cover locations BL, LM, LA, AM, RA, and T. To prevent there from being more than five spatial MV candidates in the MV candidate list for CU 360, the video coder may omit from the MV candidate list MV candidates that cover locations L and A. In this way, the above-middle candidate AM may be inserted or substituted for above candidate A and/or above-right candidate RA, and the left-middle candidate LM may be added or may replace left candidate L and/or below-left candidate BL for N×N mode. In some examples, the MV candidate list used for the first PU of CU 350 may include MV candidates that cover locations BL, LM, LA, AM, RA, and T. The MV candidate list for the second, third, and fourth PUs of CU 350 may be the same as the MV candidate list for the first PU of CU 350, except the MV candidate lists for the second, third, and fourth PU does not include the selected MV candidate for the first PU, second, and third PUs, respectively.

In other examples, the location covered by the temporal MV candidate (T) may be dependent on the partitioning mode of a CU, but the spatial MV candidate locations (i.e., the locations covered by the spatial MV candidates) may be the same for all partitioning modes and/or PUs. The spatial MV candidates are MV candidates that cover locations in the same temporal picture as the CU. For instance, in the example of FIGS. 9A-9C, the location T is at different locations, depending on the partitioning modes of CUs 350, 360, and 370. Although FIGS. 9A-9C are described in terms of a MV candidate list for merge/skip mode, similar principles may be applicable when generating a MV candidate list for AMVP mode.

In some examples, video encoder 20 may signal which MV candidate locations to use to generate a MV candidate list. For example, video encoder 20 may signal that middle MV candidates are to be used to generate a MV candidate list, but not MV candidates that cover locations A and L. In some examples, video encoder 20 may signal, at a CU level, which MV candidates are to be used to generate a MV candidate list for the CU. For instance, the type of the MV candidate list used for a particular CU and/or the way how to define a reference index can be derived, for example, from the partition type as described above. In other examples, video encoder 20 may signal, in a SPS, a PPS, or an adaptation parameter set (APS), which MV candidates are to be used to generate MV candidates for CUs associated with the SPS, PPS, or APS. That is, the type of the MV candidate list and/or the way how to define a reference index may be signaled at a CU level or may be set in SPS, PPS, or APS headers.

Similarly, video encoder 20 may signal how reference picture indexes are defined. For example, video encoder 20 may signal that the reference picture index “0” corresponds to a spatial MV candidate that covers location BL, that reference picture index “1” corresponds to a spatial MV candidate that covers location L, and so on. In some examples, video encoder 20 may signal, at a CU level, how reference picture indexes are defined. In other examples, video encoder 20 may signal, in a SPS, a PPS, or an APS, how reference picture indexes are defined for CUs associated with the SPS, PPS, or APS. In this way, this approach may be extended to the group of CUs or other blocks region allowing processing for all CUs inside that region in parallel.

As discussed above, the temporal MV candidate is a PU that is in a reference picture (i.e., a picture other than the picture that the video coder is currently coding). If the PU is in a P slice, video decoder 30 may determine which reference picture includes the temporal MV candidate by determining a reference picture index. Video decoder 30 may determine that the reference picture containing the temporal MV candidate is the reference picture in list 0 at a position indicated by the determined reference picture index. If the PU is in a B slice and is uni-directionally predicted, video decoder 30 may determine a reference picture index and may determine that the reference picture containing the temporal MV candidate is the reference picture in list 0 or list 1 at a position indicated by the determined reference picture index. If the PU is in a B slice and is bi-directionally predicted, video decoder 30 may determine a first and a second reference picture index and may determine the reference pictures containing the temporal MV candidates are reference pictures in list 0 and list 1 at locations indicated by the determined reference picture indexes.

Video decoder 30 may determine a reference picture index in various ways when determining which reference picture includes a temporal MV candidate for use in merge/skip mode or AMVP mode. For example, video decoder 30 may determine that the reference picture index is equal to a reference picture index used for inter prediction of a PU immediately to the left of the current PU (i.e., the PU that video decoder 30 is currently decoding). In this example, video decoder 30 may determine that the reference picture index is equal to zero if the reference picture index used for inter prediction of the PU immediately to the left of the current PU is not available. Other examples ways of determining the reference picture index are described in U.S. Provisional Patent Application No. 61/564,799, the entire content of which is incorporated by reference.

In the example ways of determining the reference picture index described above, video decoder 30 determines the reference picture index for each PU. However, in accordance with the techniques of this disclosure, video decoder 30 may determine the reference picture index once per CU, regardless of how the CU is partitioned into PUs. In examples where video decoder 30 determines the reference picture index once per CU, video decoder 30 may determine the reference picture index in the manner described in the examples above when the CU is partitioned into PUs according to the 2N×2N partitioning mode. For example, video decoder 30 may determine the reference picture index to be used to determine the reference picture that includes the temporal MV candidate as being the reference picture index that was used for inter prediction of a PU immediately to the left of the CU.

In other examples, video decoder 30 may determine, based at least in part on how a current CU is partitioned into PUs, the reference picture index to be used to determine the reference picture that includes the temporal MV candidate or a spatial location of the temporal MV candidate within the reference picture. Furthermore, in other examples, video decoder 30 may determine, based at least in part on a position within a CU of a PU (e.g., a PU index), the reference picture index to be used to determine the reference picture that includes the temporal MV candidate or a spatial location of the temporal MV candidate within the reference picture.

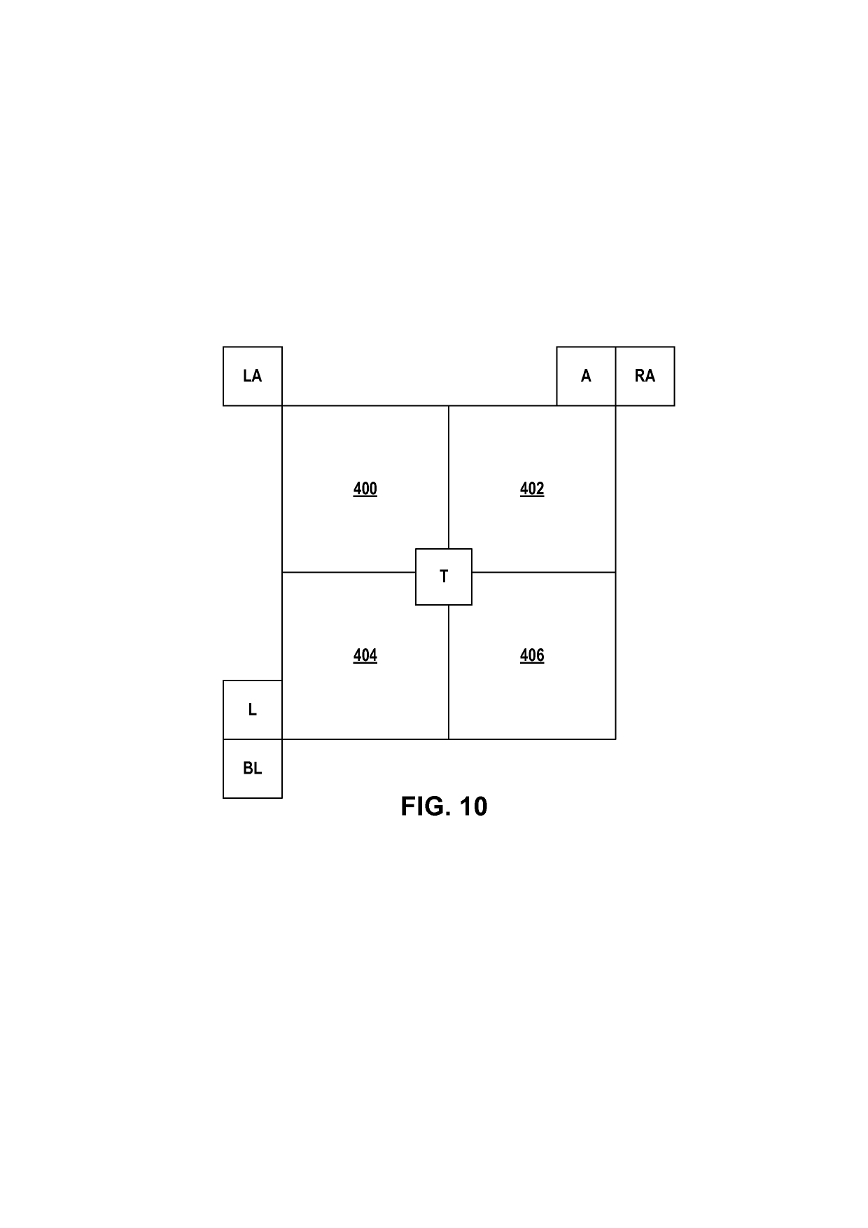

FIG. 10 is a conceptual diagram illustrating a group of CUs and a set of spatial and temporal MV candidate locations. The spatial MV candidate locations, labeled BL, L, LA, A, and RA, are locations covered by spatial MV candidates. The temporal MV candidate location, labeled T, is a location that is within a different temporal picture and that is covered by a temporal MV candidate. In the example of FIG. 10, a video coder (e.g., video encoder 20 and/or video decoder 30) generates a single MV candidate list for a group of CUs, 400, 402, 404, and 406. The MV candidate list for CUs 400, 402, 404, and 406 includes MV candidates that cover spatial MV candidate locations BL, L, LA, A, and RA and includes a MV candidate that covers temporal MV candidate location T. Because the video coder generates a single MV candidate list for CUs 400, the video coder may be able to code CUs 400, 402, 404, and 406 in parallel. In other examples, a similar technique may be applied to groups of blocks other than groups of CUs.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for encoding video data, the method comprising encoding a coding unit (CU) of the video data, the CU having at least a first prediction unit (PU) and a second PU, wherein encoding the CU comprises:
generating a first motion vector (MV) candidate list, the first MV candidate list including a plurality of MV candidates;
selecting, from the first MV candidate list, a MV candidate for the first PU;
generating a second MV candidate list, the second MV candidate list including each of the MV candidates in the first MV candidate list except the MV candidate selected for the first PU; and
selecting, from the second MV candidate list, a MV candidate for the second PU.

2. The method of claim 1, wherein the second MV candidate list consists of each MV candidate in the first MV candidate list except the MV candidate selected for the first PU.

3. The method of claim 1 further comprising:
signaling an index of the MV candidate selected for the first PU; and
signaling an index of the MV candidate selected for the second PU.

4. The method of claim 3, wherein a maximum number of bits used to signal indexes of the MV candidates in the second MV candidate list is less than a maximum number of bits used to signal indexes the MV candidates in the first MV candidate list.

5. The method of claim 3, wherein:
signaling the index of the MV candidate selected for the first PU comprises signaling a truncated unary codeword that indicates the index of the MV candidate selected for the first PU; and
signaling the index of the MV candidate selected for the second PU comprises signaling a truncated unary codeword that indicates the index of the MV candidate selected for the second PU.

6. The method of claim 1, wherein each MV candidate in the first MV candidate list includes one or more spatial MV candidates and a temporal MV candidate, the spatial MV candidates covering locations adjacent to a sample block of the CU, and the temporal MV candidate being in a reference picture.

7. The method of claim 1 further comprising using one of the following partitioning modes to partition the CU into PUs: N×2N, 2N×N, N×N, 2N×nU, 2N×nD, nL×2N, and nR×2N.

8. The method of claim 1, wherein the maximum number of MV candidates in the first MV candidate list is five and the maximum number of MV candidates in the second MV candidate list is four.

9. The method of claim 1, further comprising:
generating a predictive sample block for the first PU based at least in part on a reference block indicated by motion information of the MV candidate selected for the first PU; and
generating a predictive sample block for the second PU based at least in part on a reference block indicated by motion information of the MV candidate selected for the second PU.

10. The method of claim 9, wherein motion information of the first PU and the second PU is signaled using merge/skip mode, the motion information of the MV candidate selected for the first PU includes a MV that specifies a spatial displacement between a sample block of the first PU and the reference block, and the motion information of the MV candidate selected for the second PU includes a MV that specifies a spatial displacement between a sample block of the second PU and the reference block.

11. The method of claim 1, further comprising signaling a motion vector difference (MVD) for the first PU and a MVD for the second PU.

12. A method for decoding video data, the method comprising:
generating a first motion vector (MV) candidate list, the first MV candidate list including a plurality of MV candidates;
generating, based in part on motion information of a selected MV candidate in the first MV candidate list, a predictive sample block for a first prediction unit (PU) of a coding unit (CU);
generating a second MV candidate list, wherein the second MV candidate list includes each MV candidate in the first MV candidate list except the selected MV candidate in the first MV candidate list;
generating, based in part on motion information of a MV candidate in the second MV candidate list, a predictive sample block for a second PU of the CU; and
generating, based in part on the predictive sample blocks of the first and second PUs, a sample block of the CU.

13. The method of claim 12, wherein the second MV candidate list consists of each MV candidate in the first MV candidate list except the selected MV candidate in the first MV candidate list.

14. The method of claim 12, further comprising:
parsing, from a bitstream, a first MV index and a second MV index; and
determining, based on the first MV index, the selected MV candidate in the first MV candidate list; and
determining, based on the second MV index, the selected MV candidate in the second MV candidate list.

15. The method of claim 14, wherein a maximum number of bits in the second MV index is less than a maximum number of bits in the first MV index.

16. The method of claim 14, wherein parsing the first MV index and the second MV index comprises parsing truncated unary codewords that indicate the first and second MV indexes.

17. The method of claim 12, wherein each MV candidate in the first MV candidate list includes one or more spatial MV candidates and a temporal MV candidate, the spatial MV candidates covering locations adjacent to a sample block of the CU, and the temporal MV candidate being in a reference picture.

18. The method of claim 12, wherein the CU is partitioned into PUs using one of the following partitioning modes: N×2N, 2N×N, N×N, 2N×nU, 2N×nD, nL×2N, and nR×2N.

19. The method of claim 12, wherein motion information of the first PU and motion information of the second PU is signaled using merge/skip mode.

20. The method of claim 12, wherein motion information of the first PU and motion information of the second PU is signaled using Advanced Motion Vector Prediction (AMVP) mode, and the method further comprises:
generating the predictive sample block for the first PU comprises generating, based at least in part on the motion information of the selected MV candidate in the first MV candidate list and a first motion vector difference (MVD) signaled in a bitstream, the predictive sample block for the first PU; and
generating the predictive sample block for the second PU comprises generating, based at least in part on the motion information of the selected MV candidate in the second MV candidate list and a second MVD signaled in the bitstream, the predictive sample block for the second PU.

21. A video encoding device comprising one or more processors configured to:
generate a first motion vector (MV) candidate list, the first MV candidate list including a plurality of MV candidates;
select, from the first MV candidate list, a MV candidate for a first prediction unit (PU) of a coding unit (CU);
generate a second MV candidate list, the second MV candidate list including each of the MV candidates in the first MV candidate list except the MV candidate selected for the first PU; and
select, from the second MV candidate list, a MV candidate for a second PU of the CU.

22. The video encoding device of claim 21, wherein the second MV candidate list consists of each MV candidate in the first MV candidate list except the MV candidate selected for the first PU.

23. The video encoding device of claim 21, wherein the one or more processors are configured to:
signal an index of the MV candidate selected for the first PU; and
signal an index of the MV candidate selected for the second PU.

24. The video encoding device of claim 23, wherein a maximum number of bits used to signal indexes the MV candidates in the second MV candidate list is less than a maximum number of bits used to signal indexes the MV candidates in the first MV candidate list.

25. The video encoding device of claim 23, wherein the one or more processors are configured to:
signal a truncated unary codeword that indicates the index of the MV candidate selected for the first PU; and
signal a truncated unary codeword that indicates the index of the MV candidate selected for the second PU.

26. The video encoding device of claim 21, wherein each MV candidate in the first MV candidate list includes one or more spatial MV candidates and a temporal MV candidate, the spatial MV candidates covering locations adjacent to a sample block of the CU, and the temporal MV candidate being in a reference picture.

27. The video encoding device of claim 21, wherein the one or more processors are configured to use one of the following partitioning modes to partition the CU into PUs: N×2N, 2N×N, N×N, 2N×nU, 2N×nD, nL×2N, and nR×2N.

28. The video encoding device of claim 21, wherein the maximum number of MV candidates in the first MV candidate list is five and the maximum number of MV candidates in the second MV candidate list is four.

29. The video encoding device of claim 21, wherein the one or more processors are further configured to:
generate a predictive sample block for the first PU based at least in part on a reference block indicated by motion information of the MV candidate selected for the first PU; and
generate a predictive sample block for the second PU based at least in part on a reference block indicated by motion information of the MV candidate selected for the second PU.

30. The video encoding device of claim 29, wherein motion information of the first PU and the second PU is signaled using merge/skip mode, the motion information of the MV candidate selected for the first PU includes a MV that specifies a spatial displacement between a sample block of the first PU and the reference block, and the motion information of the MV candidate selected for the second PU includes a MV that specifies a spatial displacement between a sample block of the second PU and the reference block.

31. The video encoding device of claim 21, wherein the one or more processors are further configured to signal a motion vector difference (MVD) for the first PU and a MVD for the second PU.

32. A video decoding device comprising one or more processors configured to:
generate a first MV candidate list, the first MV candidate list including a plurality of MV candidates;
generate, based in part on motion information of a selected MV candidate in the first MV candidate list, a predictive sample block for a first prediction unit (PU) of a coding unit (CU);
generate a second MV candidate list, wherein the second MV candidate list includes each MV candidate in the first MV candidate list except the selected MV candidate in the first MV candidate list;
generate, based in part on motion information of a MV candidate in the second MV candidate list, a predictive sample block for a second PU of the CU; and
generate, based in part on the predictive sample blocks of the first and second PUs, a sample block of the CU.

33. The video decoding device of claim 32, wherein the second MV candidate list consists of each MV candidate in the first MV candidate list except the selected MV candidate in the first MV candidate list.

34. The video decoding device of claim 32, wherein the one or more processors are configured to:
parse, from a bitstream, a first MV index and a second MV index; and
determine, based on the first MV index, the selected MV candidate in the first MV candidate list; and
determine, based on the second MV index, the selected MV candidate in the second MV candidate list.

35. The video decoding device of claim 34, wherein a maximum number of bits in the second MV index is less than a maximum number of bits in the first MV index.

36. The video decoding device of claim 34, wherein the one or more processors are configured to parse, from the bitstream, truncated unary codewords that indicate the first and second MV indexes.

37. The video decoding device of claim 34, wherein each MV candidate in the first MV candidate list includes one or more spatial MV candidates and a temporal MV candidate, the spatial MV candidates covering locations adjacent to a sample block of the CU, and the temporal MV candidate being in a reference picture.

38. The video decoding device of claim 34, wherein the CU is partitioned into PUs using one of the following partitioning modes: N×2N, 2N×N, N×N, 2N×nU, 2N×nD, nL×2N, and nR×2N.

39. The video decoding device of claim 32, wherein motion information of the first PU and motion information of the second PU is signaled using merge/skip mode.

40. The video decoding device of claim 32, wherein motion information of the first PU and motion information of the second PU is signaled using Advanced Motion Vector Prediction (AMVP) mode, and the one or more processors are further configured to:
generate the predictive sample block for the first PU comprises generating, based at least in part on the motion information of the selected MV candidate in the first MV candidate list and a first motion vector difference (MVD) signaled in a bitstream, the predictive sample block for the first PU; and
generate the predictive sample block for the second PU comprises generating, based at least in part on the motion information of the selected MV candidate in the second MV candidate list and a second MVD signaled in the bitstream, the predictive sample block for the second PU.

41. A video encoding device that comprises:
means for generating a first motion vector (MV) candidate list, the first MV candidate list including a plurality of MV candidates;
means for selecting, from the first MV candidate list, a MV candidate for a first prediction unit (PU) of a coding unit (CU);
means for generating a second MV candidate list, the second MV candidate list including each of the MV candidates in the first MV candidate list except the MV candidate selected for the first PU; and
means for selecting, from the second MV candidate list, a MV candidate for the second PU.

42. A video decoding device comprising:
means for generating a first motion vector (MV) candidate list, the first MV candidate list including a plurality of MV candidates;
means for generating, based in part on motion information of a selected MV candidate in the first MV candidate list, a predictive sample block for a first prediction unit (PU) of a coding unit (CU);
means for generating a second MV candidate list, wherein the second MV candidate list includes each MV candidate in the first MV candidate list except the selected MV candidate in the first MV candidate list;
means for generating, based in part on motion information of a MV candidate in the second MV candidate list, a predictive sample block for a second PU of the CU; and
means for generating, based in part on the predictive sample blocks of the first and second PUs, a sample block of the CU.

43. A computer-readable storage medium storing instructions that, when executed by one or more processors of a video encoding device, configure the video encoding device to:
generate a first motion vector (MV) candidate list, the first MV candidate list including a plurality of MV candidates;
select, from the first MV candidate list, a MV candidate for a first prediction unit (PU) of a coding unit (CU);
generate a second MV candidate list, the second MV candidate list including each of the MV candidates in the first MV candidate list except the MV candidate selected for the first PU; and
select, from the second MV candidate list, a MV candidate for a second PU of the CU.

44. A computer-readable storage medium storing instructions that, when executed by one or more processors of a video decoding device, configure the video decoding device to:
generate a first MV candidate list, the first MV candidate list including a plurality of MV candidates;
generate, based in part on motion information of a selected MV candidate in the first MV candidate list, a predictive sample block for a first prediction unit (PU) of a coding unit (CU);
generate a second MV candidate list, wherein the second MV candidate list includes each MV candidate in the first MV candidate list except the selected MV candidate in the first MV candidate list;
generate, based in part on motion information of a MV candidate in the second MV candidate list, a predictive sample block for a second PU of the CU; and
generate, based in part on the predictive sample blocks of the first and second PUs, a sample block of the CU.
